(19) United States
(12) Patent Application Publication
(10) Pub. No.: US 2023/0062061 A1
(43) Pub. Date: Mar. 2, 2023

(54) CONTROL METHOD, COMMUNICATION TERMINAL, NON-TRANSITORY COMPUTER-READABLE RECORDING MEDIUM, AND INFORMATION PROVIDING METHOD

(71) Applicant: Panasonic Intellectual Property Management Co., Ltd., Osaka (JP)

(72) Inventors: HIROSHI YAHATA, Osaka (JP); TAKAHIRO NISHI, Nara (JP); TADAMASA TOMA, Osaka (JP); TOSHIYASU SUGIO, Osaka (JP)

(21) Appl. No.: 18/053,827

(22) Filed: Nov. 9, 2022

Related U.S. Application Data
(63) Continuation of application No. PCT/JP2020/026585, filed on Jul. 7, 2020.

(30) Foreign Application Priority Data
May 29, 2020 (JP) 2020-094983

(51) Int. Cl. G06Q 30/02

(52) U.S. Cl. CPC G06Q 30/0269; G06Q 30/0267; G06Q 30/0268; G06Q 30/0641

(57) ABSTRACT

A method includes causing a computer of a communication terminal to perform a process including acquiring, in response to receipt of a beacon signal from a vending machine, identification information, type information of a plurality of drinks, and stock information of the plurality of drinks from the vending machine by using short-range wireless communication; transmitting a user ID of a user of the communication terminal to a personal information server; acquiring biological information that includes a body temperature or a body water percentage of the user corresponding to the user ID from the personal information server; generating, based on the identification information, the type information, the stock information, and the biological information, a push notification screen that recommends at least one drink suitable for hydrating the user to prevent heatstroke; and displaying the push notification screen on a display of the communication terminal.

### BACKGROUND

### 1. Technical Field

The present disclosure relates to a method executed in a communication terminal, and the like.

### 2. Description of the Related Art

Japanese Unexamined Patent Application Publication No. 2017-174320 discloses a technique of displaying food and drink provided by a vending machine on a display of a mobile terminal to enable the food and drink provided by the vending machine to be purchased via the mobile terminal.

International Publication No. 2018/042668 discloses a product purchase assistance system including an acquiring unit that acquires a list of products sold by a plurality of vending machines within a predetermined range from a mobile terminal, and a display control unit that performs control for displaying product information on the products included in the list on a display of the mobile terminal.

Japanese Unexamined Patent Application Publication No. 2011-203952 discloses a vending machine that changes in real time products to be sold to products that match an external environment (such as the season or time) and a state of a purchaser (such as the gender, age group, or body temperature).

### SUMMARY

One non-limiting and exemplary embodiment provides further improvement in the related art described above.

In one general aspect, the techniques disclosed here feature a method executed in a communication terminal, the communication terminal including a user ID for identifying a user of the communication terminal, the method including causing a computer of the communication terminal to perform a process including acquiring, in response to receipt of a beacon signal from a vending machine of drinks, from the vending machine by using short-range wireless communication, i) identification information for identifying the vending machine, ii) type information indicating product names of a plurality of drinks stored in the vending machine, and iii) stock information indicating quantities of stock of the plurality of drinks stored in the vending machine; transmitting the user ID to a personal information server that securely manages personal information including biological information that includes a body temperature or a body water percentage of the user of the communication terminal; acquiring from the personal information server, the biological information of the user corresponding to the user ID, when it is confirmed at the personal information server that the acquisition of the biological information of the user is permitted by the user; generating a push notification screen, based on the identification information, the type information, the stock information, and the biological information, wherein the push notification screen recommends at least one drink suitable for hydrating the user to prevent heatstroke, from among the plurality of drinks stored in the vending machine indicated by the identification information; and displaying the push notification screen on a display of the communication terminal.

According to the aspect described above, further improvement can be achieved.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of an overview of an information infrastructure of a vending machine management system according to embodiments of the present disclosure;

FIG. 2 is a diagram illustrating an example of a specific configuration of the vending machine management system according to the embodiments of the present disclosure;

FIG. 3 is an explanatory diagram of a beacon signal used in short-range wireless communication performed between a communication terminal and a vending machine;

FIG. 4 is a diagram illustrating an example of a table indicating a relationship between a beacon identifier (ID) and identification information for identifying a vending machine;

FIG. 5 is a diagram illustrating an example of a table indicating a relationship between a beacon ID and identification information of a vending machine;

FIG. 6 is a sequence diagram illustrating a process of short-range wireless communication using a beacon signal;

FIGS. 7A and 7B are a sequence diagram illustrating an example of an overview of a process performed in the vending machine management system in a first embodiment;

FIG. 8 is a diagram illustrating a display example of a push notification screen;

FIG. 9 is a diagram illustrating a display example of a push notification screen;

FIG. 10 is a diagram illustrating an example of a relationship between a location of the communication terminal and a location of the vending machine;

FIG. 11 is a diagram illustrating a display example of a push notification screen;

FIG. 12 is a diagram illustrating a display example of an individual purchase menu;

FIG. 13 is a diagram illustrating an example of a scene in which a user of the communication terminal selects a drink to be purchased from the individual purchase menu;

FIG. 14 is a diagram illustrating an example of a scene in which the user of the communication terminal confirms purchase of the drink;

FIG. 15 is a diagram illustrating an example of a scene in which the user of the communication terminal acquires the purchased drink;

FIG. 16 is a diagram illustrating an example of a data configuration of information stored in a memory of the communication terminal when a beacon signal is received;

FIG. 17 is a diagram illustrating an example of a biological information table;

FIG. 18 is a flowchart illustrating a drink determination process;

FIG. 19 is a diagram illustrating an example of a determination table used in the drink determination process;

FIG. 20 is a diagram illustrating an example of a work table used in the drink determination process;

FIGS. 21A and 21B are a sequence diagram illustrating an example of an overview of a process performed in a vending machine management system in a second embodiment;

FIGS. 22A and 22B are a sequence diagram illustrating an example of an overview of a process performed in a vending machine management system in a third embodiment; and

FIGS. 23A and 23B are a sequence diagram illustrating an example of an overview of a process performed in a vending machine management system in a fourth embodiment.

### DETAILED DESCRIPTIONS

### Underlying Knowledge Forming Basis of the Present Disclosure

In the related art, a vending machine merely passively sells a product in response to an access from a user. For example, even if a vending machine sells a product desired by a user at a timing when the user passes in front of or is near the vending machine, the product is not sold to the user unless the user accesses the vending machine.

In the related art described above, the vending machine merely passively sells a product in response to an access from a user. That is, the vending machine is unable to actively access the user.

The present disclosure has been made on the basis of such knowledge, and provides a technique for allowing a vending machine to actively access a user in response to a push notification and to recommend, to the user, a product which the user presumably desires at a timing when the user passes in front of or is near the vending machine.

A method according to a first aspect of the present disclosure is a method executed in a communication terminal, the communication terminal including a user ID for identifying a user of the communication terminal, the method including causing a computer of the communication terminal to perform a process including acquiring, in response to receipt of a beacon signal from a vending machine of drinks (that is, a vending machine storing drinks), from the vending machine by using short-range wireless communication, i) identification information for identifying the vending machine, ii) type information indicating product names of a plurality of drinks stored in the vending machine, and iii) stock information indicating quantities of stock of the plurality of drinks stored in the vending machine; transmitting the user ID to a personal information server that securely manages personal information including biological information that includes a body temperature or a body water percentage of the user of the communication terminal; acquiring from the personal information server, the biological information of the user corresponding to the user ID, when it is confirmed in the personal information server that the acquisition of the biological information of the user is permitted by the user; generating a push notification screen, based on the identification information, the type information, the stock information, and the biological information, wherein the push notification screen recommends at least one drink suitable for hydrating the user to prevent heatstroke, from among the plurality of drinks stored in the vending machine indicated by the identification information; and displaying the push notification screen on a display of the communication terminal.

When a person is in a hot environment for a long time, a body temperature adjusting function becomes deficient, so that the body temperature increases. In addition, because of rapid perspiration, water and salt are lost from the body, so that a body fluid balance is disturbed to cause heatstroke. Heatstroke sometimes causes life-related symptoms such as a convulsion, nausea, and fainting. Thus, sufficient attention is to be paid. However, since it is difficult to notice the progress of the symptoms of heatstroke, the symptoms sometimes become severe without being noticed.

A body temperature or a body water percentage of a user is measured in real time with a biological sensor worn by a user. The measured result is accumulated and managed by a sensor application or a personal information server from moment to moment. The use of such biological information enables detection of a sign of heatstroke.

For example, when the body temperature of the user is higher than a normal body temperature by 1° C. or the body water percentage of the user decreases by 2%, such a state is recognized as a state requiring attention to heatstroke.

According to this aspect, when a change in the biological information indicating these signs is recognized in the biological information measured by the biological sensor, the push notification screen that recommends at least one drink (for example, a sports drink) suitable for hydrating the user to prevent heatstroke is displayed on the display of the communication terminal of the user, in response to the user merely passing in front of the vending machine of drinks, irrespective of a purchase intention of the user.

A purchase menu from the vending machine of drinks is not displayed but merely the push notification screen for displaying the purchase menu is displayed. Thus, irksomeness caused by the purchase menu from the vending machine being displayed irrespective of the absence of the purchase intention of the user can be reduced.

The push notification screen is generated by taking into account the biological information that includes the body temperature or the body water percentage of the user. Thus, a drink suitable for hydrating the user to prevent heatstroke can be recommend if it is determined that hydration is necessary after determining a physical condition of the user at a timing when the user passes in front of or is near the vending machine.

When the user purchases the recommended drink, the user displays the purchase menu according to their will. Thus, the user takes the initiative in determining whether to display the purchase menu.

Thus, a drink suitable for hydrating the user to prevent heatstroke can be recommended after determining a physical condition of the user at a timing when the user passes in front of or is near the vending machine, while reducing irksomeness caused by the purchase menu of drinks being displayed on the display of the communication terminal against the intention of the user.

The push notification screen may recommend a drink suitable for hydrating the user to prevent heatstroke from among products in stock in the vending machine, along with a message prompting the user to be careful of heatstroke. In accordance with an increasing degree of the body temperature of the user or the decreasing degree of the body water percentage of the user, a product suitable for hydrating the user to prevent heatstroke may be recommended from among the products in stock in the vending machines. For example, in response to an increase in the risk of heatstroke of the user, the product recommended by the push notification screen may be changed initially from water, then to a sports drink containing a small amount of salt or electrolytes, and then to an oral rehydration solution that enables rapid hydration at the time of dehydration when the risk is higher.

The criteria are not limited to the increasing degree of the body temperature and/or the decreasing degree of the body water percentage of the user. One or more pieces of other biological information such as a heart rate, a blood pressure, or an amount of perspiration of the user may be acquired alone or additionally. The physical condition of the user may be determined based on the acquired biological information, and a drink suitable for hydrating the user to prevent heatstroke may be recommended.

In the method described above, the push notification screen may be used for displaying, on the display of the communication terminal, a purchase menu that allows the at least one drink to be purchased from among the plurality of drinks stored in the vending machine.

According to this aspect, a user who wishes to purchase a drink after viewing the push notification screen can use the push notification screen to display, on the display, the purchase menu that allows the user to purchase the at least one drink suitable for hydrating the user to prevent heatstroke. Thus, the user who wishes to purchase a drink after viewing the push notification screen can quickly purchase the at least one drink suitable for hydrating the user to prevent heatstroke.

In the method described above, the process may further include generating, when the push notification screen displayed on the display of the communication terminal is selected, an individual purchase menu for preventing heatstroke, based on the type information, the stock information, and the biological information, wherein the individual purchase menu displays the at least one drink drinks suitable for hydrating the user to prevent heatstroke, from among the plurality of drinks stored in the vending machine indicated by the identification information; and displaying the individual purchase menu on the display of the communication terminal.

According to this aspect, by selecting the push notification screen, the user who wishes to purchase a drink after viewing the push notification screen can display, on the display, the individual purchase menu, for preventing heatstroke, that displays at least one drink suitable for hydrating the user to prevent heatstroke. Thus, the user who wishes to purchase a drink after viewing the push notification screen can purchase a drink suitable for hydrating the user to prevent heatstroke.

In the method described above, the process may further include displaying, on the display on which the push notification screen is displayed, a direction indicating a transmission direction of the beacon signal transmitted from the vending machine.

According to this aspect, the direction indicating the transmission direction of the beacon signal transmitted from the vending machine is displayed on the display on which the push notification screen is displayed. Thus, the user of the communication terminal can easily know the direction in which the vending machine that sells the drink recommended in the push notification screen is present.

In the method described above, the process may further include displaying, on the display on which the individual purchase menu is displayed, a direction indicating a transmission direction of the beacon signal transmitted from the vending machine.

According to this aspect, the direction indicating the transmission direction of the beacon signal transmitted from the vending machine is displayed on the display on which the individual purchase menu is displayed. Thus, the user of the communication terminal can easily know the direction in which the vending machine storing the drinks displayed in the individual purchase menu is present.

In the method described above, the process may further include receiving a beacon signal from the vending machine of drinks; and erasing the display of the push notification screen after receipt of the beacon signal is not detected for a predetermined time.

According to this aspect, if receipt of a beacon signal from the vending machine is not detected for the predetermined time, the displayed push notification screen is hidden. Thus, when the predetermined time elapses since the user moves to a place where the beacon signal is not receivable and the user presumably does not wish to purchase any drink from the vending machine, it can be avoided that the push notification screen that recommends a drink is kept uselessly displayed on the display.

In the method described above, the at least one drink may include any one of water, a sports drink, or an oral rehydration solution.

According to this aspect, a drink including any one of water, a sports drink, or an oral rehydration solution is recommended by the push notification screen. Thus, as a drink suitable for hydrating the user of the communication terminal to prevent heatstroke, at least one of water, a sports drink, or an oral rehydration solution, each known as a drink suitable for hydration, can be recommended to the user.

In the method described above, the push notification screen may recommend, as the at least one drink, a sports drink rather than water as a risk of heatstroke of the user increases.

According to this aspect, as the risk of heatstroke of the user increases, a sports drink is recommended rather than water by the push notification screen. Thus, in response to an increase in the risk of heatstroke of the user, water is recommended first. However, the drink recommended to the user can be changed such that a sports drink containing a small amount of salt or electrolyte is then recommended in response to a further increase in the risk of heatstroke.

In the method described above, the push notification screen may recommend an oral rehydration solution rather than the sports drink as the risk of heatstroke of the user further increases.

According to this aspect, as the risk of heatstroke of the user increases, an oral rehydration solution is recommended rather than a sports drink by the push notification screen. Thus, an oral rehydration solution that enables rapid hydration at the time of dehydration can be recommended to the user who has a risk of heatstroke higher than a degree at which a sports drink is recommended.

In the method described above, the biological information may include information on a body temperature of the user, and the push notification screen may be displayed in response to an increase in the body temperature of the user by a predetermined amount.

According to this aspect, the push notification screen is displayed when the biological information indicates that the body temperature of the user has increased by the predetermined amount. Thus, it is possible to cause the user whose body temperature has increased by the predetermined amount and who is considered to have a high risk of heatstroke to visually recognize the push notification screen and recommend at least one drink suitable for hydrating the user to prevent heatstroke.

In the method described above, the biological information may include information on a body temperature of the user, and the push notification screen may recommend, as the at least one drink, a sports drink rather than water as the body temperature of the user increases.

According to this aspect, as the body temperature of the user increases, a sports drink is recommended rather than water by the push notification screen. Thus, in accordance with an increasing degree of the body temperature of the user, water is recommended first. However, the drink recommended to the user can be changed to a sports drink containing a small amount of salt or electrolyte in response to an increase in the risk of heatstroke.

In the method described above, the push notification screen may recommend an oral rehydration solution rather than the sports drink as the risk of heatstroke of the user further increases.

According to this aspect, as the body temperature of the user increases, an oral rehydration solution is recommended rather than a sports drink by the push notification screen. Thus, an oral rehydration solution that enables rapid hydration when the risk of heatstroke is high can be recommended to the user who has a larger increasing degree of the body temperature than a degree at which a sports drink is recommended.

The push notification screen described above may be displayed together with vibration and/or sound from a communication terminal 100 in accordance with an increase in the risk of heatstroke based on an increasing degree of the body temperature of the user or the body temperature.

According to this aspect, in response to detection of a larger increase in the body temperature, at least one drink suitable for hydrating the user to prevent heatstroke can be informed and recommended to the user more reliably.

In the method described above, the biological information may include information on a body water percentage of the user, and the push notification screen may be displayed in response to a decrease in the body water percentage of the user by a predetermined amount.

Alternatively, the push notification screen may be displayed in response to a decrease in a body water amount of the user decreases by a predetermined amount.

According to this aspect, the push notification screen is displayed when the biological information indicates that the body water percentage of the user has decreased by the predetermined amount. Thus, it is possible to cause the user whose body water percentage has decreased by the predetermined amount and who is considered to have a risk of heatstroke to visually recognize the push notification screen and recommend at least one drink suitable for hydrating the user to prevent heatstroke.

In the method described above, the biological information may include information on a body water percentage of the user, and the push notification screen may recommend, as the at least one drink, a sports drink rather than water as the body water percentage of the user decreases.

According to this aspect, as the body water percentage of the user decreases, a sports drink is recommended rather than water by the push notification screen. Thus, in response to a decreasing degree of the body water percentage of the user, water is recommended first. However, the drink recommended to the user can be changed to a sports drink containing a small amount of salt or electrolyte in response to an increase in the risk of heatstroke.

In the method described above, the push notification screen may recommend an oral rehydration solution rather than the sports drink as a risk of heatstroke of the user further increases.

According to this aspect, as the body water percentage of the user decreases, an oral rehydration solution is recommended rather than a sports drink by the push notification screen. Thus, an oral rehydration solution that enables rapid hydration when the risk of heatstroke is high can be recommended to the user who has a larger decreasing degree of the body water percentage than a degree at which a sports drink is recommended.

In the method described above, the biological information may include any one of a heart rate, a blood pressure, or an amount of perspiration of the user.

In the method described above, the biological information is not limited to the body temperature and/or the body water percentage of the user, and may include one or more pieces of other biological information such as a heart rate, a blood pressure, or an amount of perspiration of the user alone or additionally.

According to this aspect, the push notification screen is generated by taking into account not only the body temperature and/or the body water percentage of the user but also one or more pieces of other biological information such as the heart rate, the blood pressure, or the amount of perspiration of the user alone or additionally. Thus, a drink more suitable for the physical condition of the user can be recommended as a drink suitable for hydrating the user to prevent heatstroke.

The push notification screen described above may be displayed together with vibration and/or sound from the communication terminal 100 in accordance with an increase in the risk of heatstroke based on a decrease amount of the body water percentage, the body water percentage, or the body water amount of the user.

According to this aspect, in response to detection of a larger decrease in the body water percentage, at least one drink suitable for hydrating the user to prevent heatstroke can be informed and recommended to the user more reliably.

In the method described above, in a case where permission of the user is not confirmed in the personal information server, the biological information of the user corresponding to the user ID may be acquired from the personal information server, when the personal information server receives a permission from the communication terminal, in reply to a message transmitted from the personal information server to the communication terminal for checking whether to permit the acquisition of the biological information of the user.

The present disclosure can also be implemented as a program that causes a computer to execute each characteristic configuration included in the method according to the first aspect described above, or as a communication terminal that operates based on this program. Obviously, such a computer program can be distributed via a non-transitory computer-readable recording medium such as a compact disc read-only memory (CD-ROM) or via a communication network such as the Internet.

A method according to a second aspect of the present disclosure is a method for a vending machine management system that manages stock information for a vending machine of drinks, the information providing method including acquiring, from a communication terminal via a network, i) a user ID for identifying a user of the communication terminal, ii) identification information for identifying the vending machine, iii) type information indicating product names of a plurality of drinks stored in the vending machine, and iv) the stock information indicating quantities of stock of the plurality of drinks stored in the vending machine, wherein ii) the identification information, iii) the type information, and iv) the stock information are acquired in the communication terminal from the vending machine of drinks by using short-range wireless communication in response to receipt of a beacon signal from the vending machine; transmitting the user ID to a personal information server that securely manages biological information that includes a body temperature or a body water percentage of the user of the communication terminal; acquiring, from the personal information server, the biological information of the user corresponding to the user ID, when it is confirmed in the personal information server that the acquisition of the biological information of the user is permitted by the user; generating information of a push notification screen, based on the identification information, the type information, the stock information, and the biological information, wherein the push notification screen recommends at least one drink suitable for hydrating the user to prevent heatstroke, from among the plurality of drinks stored in the vending machine indicated by the identification information; and outputting the information of the push notification screen to the communication terminal to display the push notification screen on a display of the communication terminal.

According to this aspect, the physical condition of the user is determined based on the biological information of the user, and the push notification screen that recommends at least one drink suitable for hydrating the user to prevent heatstroke is displayed on the display of the communication terminal of the user in response to the user merely passing in front of or being near the vending machine of drinks, irrespective of a purchase intention of the user.

A purchase menu from the vending machine of drinks is not displayed but merely the push notification screen for displaying the purchase menu is displayed. Thus, irksomeness caused by the purchase menu from the vending machine being displayed irrespective of the absence of the purchase intention of the user can be reduced.

The push notification screen is generated by taking into account the biological information including the body temperature or the body water percentage of the user. Thus, the physical condition of the user may be determined at a timing when the user passes in front of or is near the vending machine, and a drink suitable for hydrating the user to prevent heatstroke can be recommend.

When the user purchases the recommended drink, the user displays the purchase menu according to their will. Thus, the user takes the initiative in determining whether to display the purchase menu.

Thus, a drink suitable for hydrating the user to prevent heatstroke can be recommended after determining a physical condition of the user at a timing when the user passes in front of or is near the vending machine, while reducing irksomeness caused by the purchase menu of drinks being displayed on the display of the communication terminal against the intention of the user.

In the method described above, the push notification screen may be used for displaying, on the display of the communication terminal, a purchase menu that allows the at least one drink to be purchased from among the plurality of drinks stored in the vending machine.

According to this aspect, a user who wishes to purchase a drink after viewing the push notification screen can use the push notification screen to display, on the display, the purchase menu that allows the user to purchase the at least one drink suitable for hydrating the user to prevent heatstroke. Thus, the user who wishes to purchase a drink after viewing the push notification screen can quickly purchase the at least one drink suitable for hydrating the user to prevent heatstroke.

The method described above may further include acquiring, from the communication terminal, information indicating that the push notification screen displayed on the display is selected; generating information of an individual purchase menu for preventing heatstroke, based on the type information, the stock information, and the biological information, wherein the individual purchase menu displays the at least one drink drinks suitable for hydrating the user to prevent heatstroke, from among the plurality of drinks stored in the vending machine indicated by the identification information; and outputting the information of the individual purchase menu to the communication terminal to display the individual purchase menu on the display of the communication terminal.

According to this aspect, by selecting the push notification screen, the user who wishes to purchase a drink after viewing the push notification screen can display, on the display, the individual purchase menu, for preventing heatstroke, that displays at least one drink suitable for hydrating the user to prevent heatstroke. Thus, the user who wishes to purchase a drink after viewing the push notification screen can purchase a drink suitable for hydrating the user to prevent heatstroke.

In the method described above, the at least one drink may include any one of water, a sports drink, or an oral rehydration solution.

According to this aspect, a drink including any one of water, a sports drink, or an oral rehydration solution is recommended by the push notification screen. Thus, as a drink suitable for hydrating the user of the communication terminal to prevent heatstroke, at least one of water, a sports drink, or an oral rehydration solution, each known as a drink suitable for hydration, can be recommended to the user.

In the method described above, the push notification screen may recommend, as the at least one drink, a sports drink rather than water as a risk of heatstroke of the user increases.

According to this aspect, as the risk of heatstroke of the user increases, a sports drink is recommended rather than water by the push notification screen. Thus, in response to an increase in the risk of heatstroke of the user, water is recommended first. However, the drink recommended to the user can be changed to a sports drink containing a small amount of salt or electrolyte in response to an increase in the risk of heatstroke.

In the method described above, the push notification screen may recommend an oral rehydration solution rather than the sports drink as a risk of heatstroke of the user further increases.

According to this aspect, as the risk of heatstroke of the user increases, an oral rehydration solution is recommended rather than a sports drink by the push notification screen. Thus, an oral rehydration solution that enables rapid hydration at the time of dehydration can be recommended to the user who has symptoms of heatstroke worse than a degree at which a sports drink is recommended.

In the method described above, the biological information may include information on a body temperature of the user, and the push notification screen may be displayed in response to an increase in the body temperature of the user by a predetermined amount.

According to this aspect, the push notification screen is displayed when the biological information indicates that the body temperature of the user has increased by the predetermined amount. Thus, it is possible to cause the user whose body temperature has increased by the predetermined amount and who is considered to have symptoms of heatstroke to visually recognize the push notification screen and recommend at least one drink suitable for hydrating the user to prevent heatstroke.

In the method described above, the biological information may include information on a body temperature of the user, and the push notification screen may recommend, as the at least one drink, a sports drink rather than water as the body temperature of the user increases.

According to this aspect, as the body temperature of the user increases, a sports drink is recommended rather than water by the push notification screen. Thus, in accordance with an increasing degree of the body temperature of the user, water is recommended first. However, the drink recommended to the user can be changed to a sports drink containing a small amount of salt or electrolyte in response to an increase in the risk of heatstroke.

In the method described above, the push notification screen may recommend an oral rehydration solution rather than the sports drink as a risk of heatstroke of the user further increases.

According to this aspect, as the body temperature of the user increases, an oral rehydration solution is recommended rather than a sports drink by the push notification screen. Thus, an oral rehydration solution that enables rapid hydration at the time of dehydration can be recommended to the user who has a higher increasing degree of the body temperature than a degree at which a sports drink is recommended.

In the method described above, the biological information may include information on a body water percentage of the user, and the push notification screen may be displayed in response to a decrease in the body water percentage of the user by a predetermined amount.

According to this aspect, the push notification screen is displayed when the biological information indicates that the body water percentage of the user has decreased by the predetermined amount. Thus, it is possible to cause the user whose body water percentage has decreased by the predetermined amount and who is considered to have symptoms of heatstroke to visually recognize the push notification screen and recommend at least one drink suitable for hydrating the user to prevent heatstroke.

In the method described above, the biological information may include information on a body water percentage of the user, and the push notification screen may recommend, as the at least one drink, a sports drink rather than water as the body water percentage of the user decreases.

According to this aspect, as the body water percentage of the user decreases, a sports drink is recommended rather than water by the push notification screen. Thus, in response to a decreasing degree of the body water percentage of the user, water is recommended first. However, the drink recommended to the user can be changed to a sports drink containing a small amount of salt or electrolyte in response to an increase in the risk of heatstroke.

In the method described above, the push notification screen may recommend an oral rehydration solution rather than the sports drink as a risk of heatstroke of the user further increases.

According to this aspect, as the body water percentage of the user decreases, an oral rehydration solution is recommended rather than a sports drink by the push notification screen. Thus, an oral rehydration solution that enables rapid hydration at the time of dehydration can be recommended to the user who has a larger decreasing degree of the body water percentage than a degree at which a sports drink is recommended.

In the method described above, the biological information may include any one of a heart rate, a blood pressure, or an amount of perspiration of the user.

In the method described above, the biological information is not limited to the body temperature and/or the body water percentage of the user, and may include any one or more pieces of other pieces of biological information such as a heart rate, a blood pressure, or an amount of perspiration of the user alone or additionally.

According to this aspect, the push notification screen is generated by taking into account not only the body temperature and/or the body water percentage of the user but also any one or more pieces of other biological information such as the heart rate, the blood pressure, or the amount of perspiration of the user alone or additionally. Thus, a drink more suitable for the physical condition of the user can be recommended as a drink suitable for hydrating the user to prevent heatstroke.

The push notification screen described above may be displayed together with vibration and/or sound from the communication terminal 100 in accordance with an increase in the risk of heatstroke based on the body temperature, the body water percentage (or the body water amount), the heart rate, the blood pressure, or the amount of perspiration of the user.

According to this aspect, in response to detection of a higher risk of heatstroke, at least one drink suitable for hydrating the user to prevent heatstroke can be informed and recommended to the user more reliably.

In the method described above, in a case where permission of the user is not confirmed in the personal information server,

the biological information of the user corresponding to the user ID may be acquired from the personal information server, when the personal information server receives a permission from the communication terminal, in reply to a message transmitted from the personal information server to the communication terminal for checking whether to permit reading of the biological information of the user.

A method according to a third aspect is a method executed in a communication terminal, the communication terminal including a user ID for identifying a user of the communication terminal, the method including causing a computer of the communication terminal to perform a process including: acquiring, in response to receipt of a beacon signal from a vending machine of drinks, from the vending machine by using short-range wireless communication, i) identification information for identifying the vending machine, ii) type information indicating product names of a plurality of drinks stored in the vending machine, and iii) stock information indicating quantities of stock of the plurality of drinks stored in the vending machine; transmitting the user ID to a personal information server that securely manages personal information including biological information that includes a body temperature or a body water percentage of the user of the communication terminal; acquiring from the personal information server, when it is confirmed in the personal information server that the acquisition of the biological information of the user is permitted by the user; calculating, based on the biological information, an increasing degree of the body temperature of the user or a decreasing degree of the body water percentage of the user; generating a push notification screen, based on the identification information, the type information, the stock information, and the increasing degree of the body temperature of the user or the decreasing degree of the body water percentage of the user, wherein the push notification screen recommends at least one drink suitable for hydrating the user to prevent heatstroke from among the plurality of drinks stored in the vending machine indicated by the identification information; and displaying the push notification screen on a display of the communication terminal.

In the method described above, the increasing degree of the body temperature of the user may include i) an increase amount of the body temperature of the user in a predetermined time or ii) an increase amount of the body temperature from a normal body temperature of the user, and the decreasing degree of the body water percentage of the user may include i) a decrease amount of the body water percentage of the user in a predetermined time or ii) a decrease amount of the body water percentage from a normal body water percentage of the user.

A method according to a fourth aspect is a method for a vending machine management system that manages stock information for a vending machine of drinks, the information providing method including: acquiring, from a communication terminal via a network, i) a user ID for identifying a user of the communication terminal, ii) identification information for identifying the vending machine, iii) type information indicating product names of a plurality of drinks stored in the vending machine, and iv) stock information indicating quantities of stock of the plurality of drinks stored in the vending machine, wherein ii) the identification information, iii) the type information, and iv) the stock information are acquired in the communication terminal from the vending machine of drinks by using short-range wireless communication in response to receipt of a beacon signal from the vending machine; transmitting the user ID to a personal information server that securely manages biological information that includes a body temperature or a body water percentage of the user of the communication terminal; acquiring, from the personal information server, the biological information of the user corresponding to the user ID, when it is confirmed in the personal information server that the acquisition of the biological information of the user is permitted by the user; calculating, based on the biological information, an increasing degree of the body temperature of the user or a decreasing degree of the body water percentage of the user; generating information of a push notification screen, based on the identification information, the type information, the stock information, and the increasing degree of the body temperature of the user or the decreasing degree of the body water percentage of the user, wherein the push notification screen recommends at least one drink suitable for hydrating the user to prevent heatstroke, from among the plurality of drinks stored in the vending machine indicated by the identification information; and outputting the information of the push notification screen to the communication terminal to display the push notification screen on a display of the communication terminal.

In the method described above, the increasing degree of the body temperature of the user may include i) an increase amount of the body temperature of the user in a predetermined time or ii) an increase amount of the body temperature from a normal body temperature of the user, and the decreasing degree of the body water percentage of the user may include i) a decrease amount of the body water percentage of the user in a predetermined time or ii) a decrease amount of the body water percentage from a normal body water percentage of the user.

A method according to a fifth aspect is a method executed in a communication terminal, the communication terminal including a user ID for identifying a user of the communication terminal, the method including causing a computer of the communication terminal to perform a process including: in response to receipt, by using short-range wireless communication, of a beacon signal from a sales site of a business entity that sells drinks, acquiring, from the sales site, i) type information for identifying a plurality of drinks sold at the sales site and ii) stock information of the plurality of drinks sold at the sales site; transmitting the user ID to a first server that securely manages personal information including biological information that includes a body temperature or a body water percentage of the user; acquiring the biological information from the first server, the biological information being provided in response to confirmation in the first server that the user permits the business entity that sells the drinks to access the biological information; and displaying, on a display of the communication terminal, a notification screen that recommends at least one drink to the user based on at least the type information, the stock information, and the biological information.

### EMBODIMENTS

It is expected that the Internet becomes further widespread in the future and various sensors become commonplace in our society. It is thus expected that not only information on states, activities, and the like of individuals but also information on the entire city including buildings, traffic networks, and the like are digitized to be usable in a computer system in our society. Digitized data on individuals (personal information) is accumulated in a cloud via a communication network, managed as big data in an information bank, and used for various purposes for individuals.

In Japan, such an advanced information society is called Society 5.0. The advanced information society is a society in which economic advancement and solution of social problems are expectedly brought by an information infrastructure (cyber-physical system) that highly integrates a real space (physical space) and a virtual space (cyberspace) together.

In Society 5.0, personal information such as biological information is centrally managed by a server of a personal-information managing business entity called an information bank after being anonymized so that the individuals are not to be specified by a third party. The personal information is updated at any time under the management of the information bank without intervention of manual input performed by a user of a terminal. When an individual makes a decision in various daily situations, big data including the accumulated personal information is analyzed, so that the individual can be informed of an option that is presumably optimal for the individual in the situation at that time.

### Overview of Information Infrastructure of Vending Machine Management System

A vending machine management system according to embodiments of the present disclosure is a system configured by taking into account Society 5.0, and is a system that manages stock information for vending machines of drinks and recommends, to a user, a drink suitable for hydrating the user to prevent heatstroke by using personal information managed by an information bank.

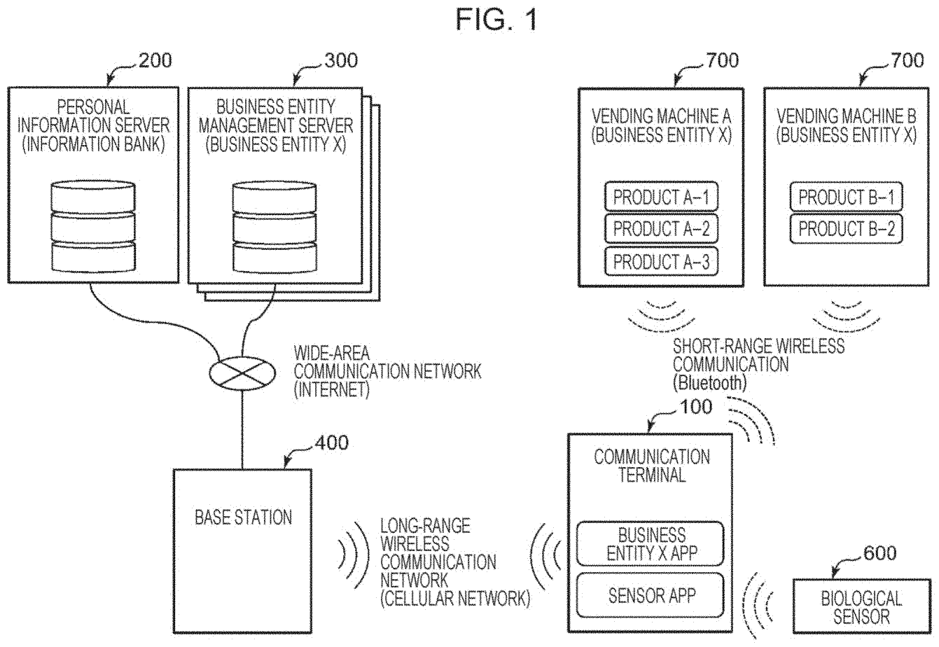

The vending machine management system according to the embodiments of the present disclosure will be described below with reference to the drawings. FIG. 1 is a diagram illustrating an example of an overview of an information infrastructure of a vending machine management system according to embodiments of the present disclosure. An overview of the information infrastructure for implementing embodiments of the present disclosure will be described first with reference to FIG. 1. This vending machine management system includes roughly three groups of devices.

A first group of devices is a group of devices that serves as physical sales sites where a plurality of business entities sell products (goods), and includes vending machines 700 that sell products of individual business entities. FIG. 1 illustrates the vending machine 700 that sells products A-1, A-2, and A-3 of a business entity X and the vending machine 700 that sells products B-1 and B-2 of the business entity X.

A second group of devices is a group of devices carried by users, and includes the communication terminal 100 such as a smartphone or a tablet terminal and a biological sensor 600 such as a smartwatch. The communication terminal 100 can be connected to a wide-area communication network such as the Internet via a base station 400 by a long-range wireless communication network such as a cellular network called 4G or 5G, for example. The communication terminal 100 is capable of communicating with the vending machines 700 by short-range wireless communication such as Bluetooth (registered trademark).

The communication terminal 100 includes an application provided by each business entity and a sensor application installed thereon. FIG. 1 illustrates an example in which a business entity X application (also referred to as “business entity X app”) provided by the business entity X and a sensor application (also referred to as “sensor app”) are installed on the communication terminal 100. The business entity X application is an application for recommending a drink suitable for hydrating a user to prevent heatstroke from among a plurality of drinks sold by the vending machines 700 managed by the business entity X, by using personal information of the user. The sensor application will be described later.

The biological sensor 600 periodically and continuously measures biological information of a user carrying the biological sensor 600. The biological information measured by the biological sensor 600 may include information on a body water percentage and/or a body temperature. The biological information measured by the biological sensor 600 may include information on at least one piece of other biological information such as a heart rate, a blood pressure, or an amount of perspiration alone or additionally. These pieces of information may be measured directly by a sensor that is in contact with the body of the user, or may be derived indirectly, for example, from a video of the user in a visible and/or non-visible light range. These pieces of information may be measured not only by one sensor but also by a plurality of sensors such as a bioelectrical impedance sensor, a body temperature sensor, a blood pressure sensor, a heart rate sensor, and a perspiration amount sensor. In this case, as for overlapping biological information, the measured biological information may be weighted in accordance with precisions of the sensors to acquire the biological information, or the biological information measured by one sensor selected by the user may be acquired. Alternatively, biological information measured by the most recently released sensor may be acquired as a representative value, based on the product number information of each sensor.

The biological information measured by the biological sensor 600 is sent from the biological sensor 600 to the communication terminal 100 by short-range wireless communication such as Bluetooth (registered trademark). The biological information may be stored and/or managed by the sensor application installed on the communication terminal 100. The biological sensor 600 may be included in the communication terminal 100.

The sensor application uploads the collected biological information and measurement date and time information indicating a measurement date and time of the biological information to a personal information server 200 in accordance with user account information. The user account information includes a user ID, a password, and the like. Consequently, the biological information is stored in the personal information server 200 in time series in association with the user ID and the measurement date and time information.

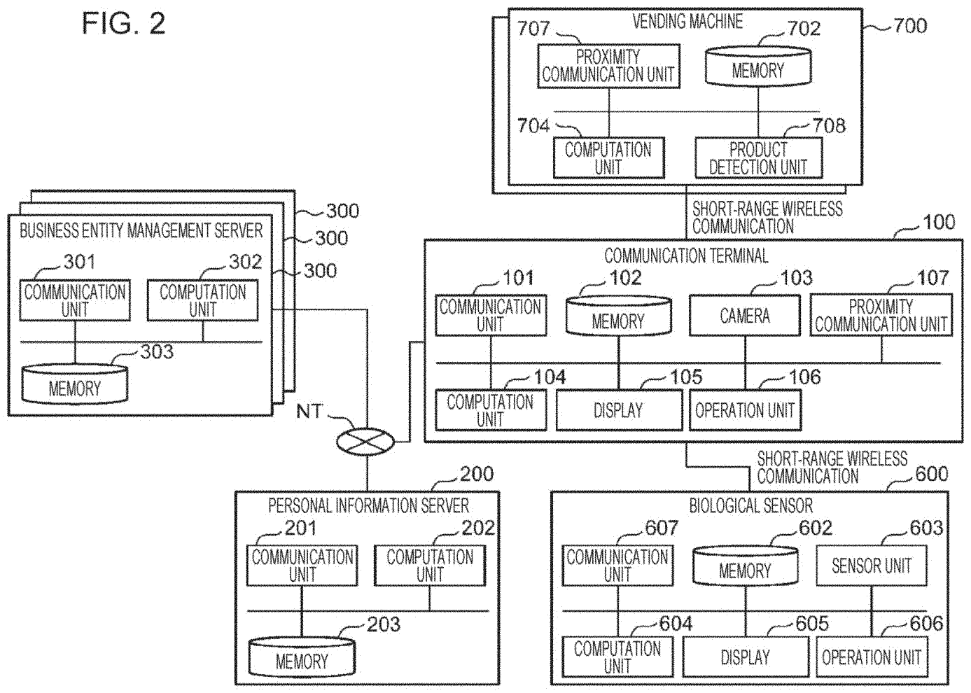

The sensor application may store the biological information in a memory 102 (FIG. 2) of the communication terminal 100. The sensor application may authorize the business entity X application or an operating system (OS) of the communication terminal 100 to access the biological information stored in the memory 102 (FIG. 2). In this case, the biological information is uploaded to the personal information server 200 via the business entity X application or the OS.

A third group of devices is a group of servers that store and/or manage information used by a plurality of users via a wide-area communication network such as the Internet, and includes the personal information server 200 and a business entity management server 300.

The personal information server 200 is a personal information server that distributes personal information of a user to a plurality of locations, encrypts the distributed personal information, and stores the distributed encrypted personal information. The personal information server 200 manages personal information of a user by fragmenting, encrypting, and storing the personal information in a plurality of storage devices over a wide-area communication network. Thus, high security is ensured and leakage of the personal information is prevented.

The personal information server 200 has a function of returning, in response to an inquiry from a third party, necessary information in accordance with permission of the user. The personal information server 200 also has a function of securely sharing the personal information permitted by the user with the business entity permitted by the user. That is, the personal information server 200 has a function of an information bank.

The term “personal information” used herein broadly includes public or private information related to individuals. For example, the personal information includes at least one of a name, a date of birth, an address, an annual income, owned movable property/real estate information, physical information such as height/weight, genetic information, allergy information, medical information such as medical history/diagnosis chart, activity amount information such as number of steps/calorie consumption, meal history information, biological information such as heart rate/body temperature/body water percentage/blood pressure/amount of perspiration, product purchase history information through a vending machine/store/electronic-commerce (EC) site, word information searched by a web search engine/artificial intelligence (AI) speaker, or text/video/audio information sent/received by mail/social networking service (SNS).

The business entity management server 300 is a server in which each business entity stores and/or manages data unique to the business entity. FIG. 1 illustrates a state in which the business entity X and two other entities each own or rent the business entity management server 300 and store and/or manage information on products of the business entity. In the description below, the business entity X is a business entity that sells drinks.

### Specific Configuration of Vending Machine Management System

A specific configuration of the vending machine management system according to the embodiments of the present disclosure will be described next. FIG. 2 is a diagram illustrating an example of a specific configuration of the vending machine management system according to the embodiments of the present disclosure. The vending machine management system illustrated in FIG. 2 includes the vending machines 700 managed by respective business entities, the communication terminal 100, the personal information server 200, the business entity management servers 300 managed by respective business entities, and the biological sensor 600 which are described in FIG. 1.

The communication terminal 100, the personal information server 200, and the business entity management servers 300 are connected to one another via a network NT to be able to communicate with one another. The network NT is a wide-area communication network including the Internet and a long-range wireless communication network such as a cellular network. In FIG. 2, the base station 400 illustrated in FIG. 1 is not illustrated for convenience of explanation. In the description below, the vending machines 700 are the vending machines 700 of drinks managed by the business entity X, and the business entity management servers 300 are the business entity management servers 300 managed by the business entity X.

Each of the vending machines 700 includes a memory 702, a product detection unit 708, a proximity communication unit 707, and a computation unit 704 that controls the memory 702, the product detection unit 708, and the proximity communication unit 707.

The memory 702 is a nonvolatile storage device such as a flash memory. The memory 702 stores information on the vending machine 700. The information on the vending machine 700 is input by a worker using an input device such as a touch panel (not illustrated) when the worker stores each drink in the vending machine 700, and is stored in the memory 702 by the computation unit 704.

Specifically, the information on the vending machine 700 includes identification information (second identification information) for identifying the vending machine 700 and product information on a plurality of drinks stored in the vending machine 700.

The identification information for identifying the vending machine 700 includes a business entity identifier (ID) and a vending machine ID. The business entity ID is an identifier of a business entity that manages the vending machine 700. The vending machine ID is an identifier of the vending machine 700.

The product information includes type information indicating types of the plurality of drinks stored in the vending machine 700, and stock information indicating quantities of stock of the plurality of drinks stored in the vending machine 700. The type information includes kind information indicating kinds of the plurality of drinks stored in the vending machine 700, and product name information indicating product names of the plurality of drinks. The stock information includes price information indicating prices of the plurality of drinks stored in the vending machine 700, quantity information indicating quantities of the plurality of drinks, and temperature information indicating temperatures of the plurality of drinks.

The product detection unit 708 includes, for example, a processor such as a central processing unit (CPU) and a temperature sensor. The product detection unit 708 reads the product information from the memory 702. The product detection unit 708 also measures a temperature of each stored drink with the temperature sensor. The product detection unit 708 updates the temperature information included in the product information of each drink which is stored in the memory 702, with the information indicating the measured temperature of the drink.

The product detection unit 708 measures the temperature of each drink to control the temperature of each drink around a target temperature, which is 5° C. for cold-storage drinks and 55° C. for hot-storage drinks. If the temperature of the drink that has just stored does not reach the target temperature, the sale of this drink is not recommended. Thus, if the measured temperature of the drink is within a predetermined temperature range around the target temperature, the product detection unit 708 detects the drink as a product available for sale; otherwise, the product detection unit 708 detects the drink as a product not available for sale since the drink is in a preparation stage before the sale.

The proximity communication unit 707 includes, for example, a communication circuit that performs short-range wireless communication in accordance with the Bluetooth Low Energy (BLE) standard, which is part of the Bluetooth (registered trademark) standard. The proximity communication unit 707 may further include a communication circuit that performs short-range wireless communication in accordance with the Near Field Communication (NFC) standard. The computation unit 704 includes, for example, a processor such as a CPU.

The proximity communication unit 707 periodically transmits a beacon signal in the case of performing short-range wireless communication according to the BLE standard. In response to receipt of a signal indicating a connection request from the communication terminal 100 that is located in a short range and has received the beacon signal, the proximity communication unit 707 notifies the computation unit 704 of the receipt of the signal indicating the connection request. In response to receipt of the notification, the computation unit 704 reads the identification information for identifying the vending machine 700 from the memory 702 and further controls the product detection unit 708 to read the product information on drinks detected as products available for sale and drinks detected as products not available for sale from the memory 702. The computation unit 704 controls the proximity communication unit 707 to return the read identification information of the vending machine 700 and product information to the communication terminal 100 that has sent the signal indicating the connection request.

In response to receipt of information indicating drink purchase details from a proximity communication unit 107 of the communication terminal 100, the proximity communication unit 707 outputs the received information indicating the drink purchase details to the computation unit 704. The information indicating the drink purchase details includes, for example, a product name of the purchased drink, a quantity of purchase of the drink, and a total amount required to purchase the drink.

In response to acquisition of the information indicating the drink purchase details via the proximity communication unit 707, the computation unit 704 controls a transport mechanism (not illustrated) to transport the purchased drink indicated by the acquired information to a pick-up port as many times as the quantity of purchase indicated by the information.

A configuration of the communication terminal 100 will be described next. The communication terminal 100 includes the proximity communication unit 107, a communication unit 101, the memory 102, a camera 103, a computation unit 104, a display 105, and an operation unit 106.

Similarly to the proximity communication unit 707 of the vending machine 700, the proximity communication unit 107 includes, for example, a communication circuit that performs short-range wireless communication in accordance with the Bluetooth Low Energy (BLE) standard, which is part of the Bluetooth (registered trademark) standard. The proximity communication unit 107 may further include a communication circuit that performs short-range wireless communication in accordance with the Near Field Communication (NFC) standard.

In the case of performing short-range wireless communication according to the BLE standard, in response to receipt of a beacon signal transmitted from the vending machine 700, the proximity communication unit 107 returns a signal indicating a connection request to the vending machine 700. The proximity communication unit 107 receives the identification information of the vending machine 700 and the product information, which are returned from the proximity communication unit 707 of the vending machine 700 in response to the signal indicating the connection request. The proximity communication unit 107 outputs the received identification information and product information to the computation unit 104.

The proximity communication unit 107 receives various types of biological information measured by the biological sensor 600 from the biological sensor 600. The proximity communication unit 107 outputs the received biological information to the computation unit 104.

The communication unit 101 includes a communication circuit that connects the communication terminal 100 to the network NT. In response to receipt of information sent from the personal information server 200 and/or the business entity management server 300, the communication unit 101 outputs the received information to the computation unit 104. The communication unit 101 sends the identification information of the vending machine 700 and the product information to the business entity management server 300 in association with each other under the control of the computation unit 104. The communication unit 101 also sends purchase information (described later) to the business entity management server 300 and/or the personal information server 200 under the control of the computation unit 104.

The memory 102 includes a nonvolatile storage device such as a flash memory. The memory 102 stores identification information (first identification information) for identifying the communication terminal 100. The identification information for identifying the communication terminal 100 includes a terminal identifier (ID) and a user identifier (ID). The terminal ID is an identifier of the communication terminal 100. The user ID is an identifier of a user of the communication terminal 100. The identification information for identifying the communication terminal 100 is stored in the memory 102 when the communication terminal 100 is purchased.

The camera 103 is an imaging device including a complementary metal-oxide semiconductor (CMOS) sensor or the like.

The computation unit 104 includes a processor such as a CPU. The computation unit 104 executes the OS of the communication terminal 100, the business entity X application, the sensor application, a quick response (QR) code (registered trademark) reader, a browser, and so on.

The computation unit 104 executes the business entity X application to perform processing below.

The computation unit 104 controls the proximity communication unit 107 to perform processing of acquiring identification information for identifying the vending machine 700 and product information including type information and stock information from the vending machine 700 by using short-range wireless communication, in response to receipt of a beacon signal transmitted from the vending machine 700 of drinks provided by the business entity X.

The computation unit 104 performs processing of acquiring biological information that includes a body temperature and/or a body water percentage of the user of the communication terminal 100.

The computation unit 104 further performs processing of determining, based on the pieces of information acquired in the processing, at least one drink suitable for hydrating the user to prevent heatstroke from among a plurality of drinks stored in the vending machine 700 which is a transmission source of the beacon signal received by the proximity communication unit 107, and generating a push notification screen that recommends the determined at least one drink. The computation unit 104 performs processing of generating an individual purchase menu for prevention of a heatstroke displaying the determined at least one drink.

The computation unit 104 executes the sensor application to acquire, via the proximity communication unit 107, various types of biological information continuously measured by the biological sensor 600. If the communication terminal 100 includes the biological sensor 600, the computation unit 104 executes the sensor application to acquire various types of biological information continuously measured by the biological sensor 600.

The computation unit 104 stores the biological information acquired from the biological sensor 600 and date and time information indicating the acquisition date and time in the memory 102. The biological information and the date and time information are uploaded to the personal information server 200 via the communication unit 101 together with the user account information.

The computation unit 104 may execute or operate the sensor application to store the biological information and the date and time information in the memory 102. The sensor application may authorize the business entity X application or the OS of the communication terminal 100 to access the biological information stored in the memory 102. In this case, the business entity X application or the OS may upload the biological information to the personal information server 200.

The display 105 includes, for example, a liquid crystal display panel or an organic electroluminescence (EL) panel, and displays various images. For example, the display 105 displays the push notification screen described above, an individual purchase menu (described below), and so on.

The operation unit 106 includes, for example, an input device such as a touch panel. For example, the operation unit 106 receives an operation of selecting and purchasing a drink desired by the user from the individual purchase menu (described below).

A configuration of the personal information server 200 will be described next. The personal information server 200 includes a communication unit 201, a computation unit 202, and a memory 203. The communication unit 201 includes a communication circuit that connects the personal information server 200 to the network NT. In response to a request from the communication terminal 100 or the business entity management server 300, the communication unit 201 returns personal information of each user under the control of the computation unit 202.

The computation unit 202 includes a processor such as a CPU. For example, the communication unit 201 receives a signal requesting acquisition of personal information on a user with permission. The user with permission is a user who has given, directly or indirectly via a trusted third party, permission to read their personal information stored in the personal information server 200 and requested by the communication terminal 100 or the business entity management server 300. In this case, in response to a request from the communication terminal 100 or the business entity management server 300, the computation unit 202 reads the personal information of the user with permission stored in the memory 203 and causes the communication unit 201 to return the personal information. The personal information to be read may be the entire personal information that is managed, or only information related to a requested particular item in the personal information (only part of the personal information) may be exchanged.

The memory 203 includes a plurality of nonvolatile storage devices such as hard disk drives. The memory 203 stores personal information of one or more users. The personal information is stored in the plurality of storage devices after being distributed and encrypted.

The personal information stored in the memory 203 includes purchase history information and biological information. The purchase history information is information indicating a purchase history of products such as drinks purchased by each user. The biological information is information indicating a physical condition of each user. The biological information includes information on a body water percentage or a body temperature of each user. The biological information may include at least one piece of other biological information such as a heart rate, a blood pressure, or an amount of perspiration of each user alone or additionally.

A configuration of the business entity management server 300 will be described next. There are one or more business entity management servers 300 that correspond to respective business entities. Each of the business entity management servers 300 includes a memory 303, a communication unit 301, and a computation unit 302.

The memory 303 includes a nonvolatile storage device such as a hard disk drive. The memory 303 stores, in association with identification information for identifying each of the plurality of vending machines 700 managed by the business entity X, product information on a plurality of drinks stored in the vending machine 700 and location information indicating an installed location of the vending machine 700. The product information includes type information indicating types of the plurality of drinks stored in each vending machine 700, and stock information indicating quantities of stock of the plurality of drinks stored in the vending machine 700. The type information includes kind information indicating kinds of the plurality of drinks stored in the vending machine 700, and product name information indicating product names of the plurality of drinks. The stock information includes price information indicating prices of the plurality of drinks stored in the vending machine 700, quantity information indicating quantities of the plurality of drinks, and temperature information indicating temperatures of the plurality of drinks.

The communication unit 301 includes a communication circuit that connects the business entity management server 300 to the network NT. The communication unit 301 receives the identification information for identifying the vending machine 700 and the product information that are sent from the communication terminal 100, and outputs the received identification information of the vending machine 700 and product information to the computation unit 302.

The computation unit 302 includes a processor such as a CPU. Based on the identification information of the vending machine 700 and the product information that are sent from the communication terminal 100 and acquired via the communication unit 301, the computation unit 302 updates the product information of the vending machine 700 corresponding to the identification information and stored in the memory 303.

### Beacon Signal Used in Short-Range Wireless Communication

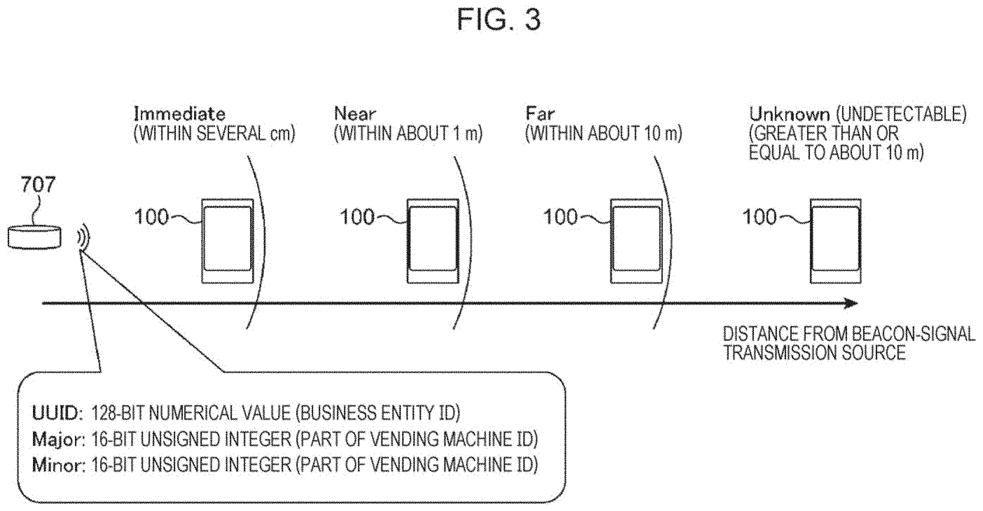

A beacon signal used in short-range wireless communication performed between the communication terminal 100 and the vending machine 700 will be described next with reference to FIG. 3. FIG. 3 is an explanatory diagram of a beacon signal used in short-range wireless communication performed between the communication terminal 100 and the vending machine 700.

As described above, short-range wireless communication using a beacon signal is performed between the proximity communication unit 107 of the communication terminal 100 and the proximity communication unit 707 of the vending machine 700 in accordance with the BLE (Bluetooth Low Energy) standard, which is part of the Bluetooth (registered trademark) standard.

The beacon signal is periodically transmitted from the proximity communication unit 707 of the vending machine 700. As illustrated in FIG. 3, in response to receipt of a beacon signal, the proximity communication unit 107 of the communication terminal 100 may represent the distance from the proximity communication unit 707 as roughly four types, which are immediate, near, far, and unknown, depending on a radio field intensity of the signal.

Specifically, the proximity communication unit 107 of the communication terminal 100 grasps that the distance from the proximity communication unit 707 is “immediate” based on the radio field intensity of the beacon signal received when the distance from the proximity communication unit 707 is within several centimeters. Likewise, the proximity communication unit 107 of the communication terminal 100 grasps that the distance from the proximity communication unit 707 is near/far based on the radio field intensity of the beacon signal received when the distance from the proximity communication unit 707 is within about 1 m/about 10 m, respectively.

When the distance from the proximity communication unit 707 is longer (for example, greater than or equal to about 10 m), the proximity communication unit 107 of the communication terminal 100 may fail to receive (detect) the beacon signal transmitted from the proximity communication unit 707. In this case, the proximity communication unit 107 of the communication terminal 100 grasps that the distance from the proximity communication unit 707 is unknown since the distance is too far for the beacon signal to reach the proximity communication unit 107.

However, the method by which the proximity communication unit 107 of the communication terminal 100 grasps the distance from the proximity communication unit 707 that has transmitted the beacon signal is not limited to this. For example, the proximity communication unit 107 of the communication terminal 100 may grasp the distance from the proximity communication unit 707 that has transmitted the beacon signal, based on a received signal strength indicator (RSSI) which is a measurement value of the radio field intensity of the beacon signal received from the proximity communication unit 707, or may grasp the distance using another method.

The beacon signal transmitted from the proximity communication unit 707 includes a beacon ID which is an identifier of the beacon signal. For example, in the iBeacon (registered trademark) standard of Apple Inc., the beacon ID includes a Universally Unique Identifier (UUID) which is 128 bits long, and major and minor values each of which is a 16-bit unsigned integer.

The UUID is an identifier for uniquely identifying an object on software. In this case, for example, a 128-bit numerical value indicating the business entity ID and a 32-bit numerical value indicating the vending machine ID are stored in the memory 702. The proximity communication unit 707 transmits a beacon signal in which the 128-bit numerical value indicating the business entity ID stored in the memory 702 is set as the UUID and the 32-bit numerical value indicating the vending machine ID stored in the memory 702 is set as the major and minor values.

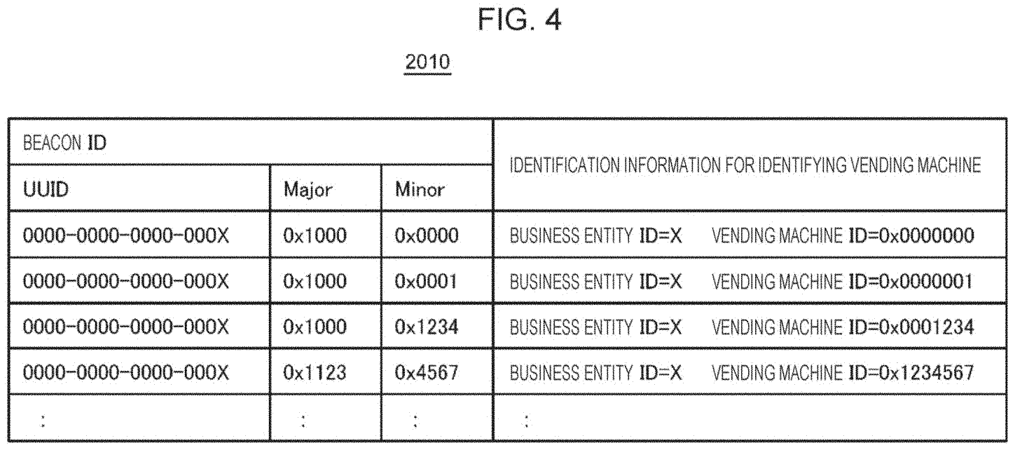

FIG. 4 is a diagram illustrating an example of a table indicating a relationship between a beacon ID and identification information for identifying the vending machine 700. When the business entity X application is installed, a table 2010 indicating a relationship between a beacon ID and identification information for identifying the vending machine 700 illustrated in FIG. 4 is stored in the memory 102 of the communication terminal 100. In response to receipt of a beacon signal, the proximity communication unit 107 of the communication terminal 100 refers to the table 2010 stored in the memory 102 to acquire identification information for identifying the vending machine 700 associated with the beacon ID included in the received beacon signal.

For example, the UUID, the major value, and the minor value of the beacon ID included in the beacon signal received by the proximity communication unit 107 are “0000-0000-0000-000X”, “0x1000”, and “0x0000”, respectively. In this case, the proximity communication unit 107 refers to the table 2010 illustrated in FIG. 4 to acquire identification information for identifying the vending machine 700 which is “business entity ID=X vending machine ID=0x00000000”.

The beacon ID may comply with a frame type Eddystone-UID defined by the Eddystone (registered trademark) standard of Google Inc., for example. In this case, the beacon ID includes a frame type to which a fixed value 0 is set, a 10-byte namespace ID, and a 6-byte instance ID.

In this case, for example, a 10-byte value indicating the business entity ID and a 6-byte value indicating the vending machine ID are stored in the memory 702. The proximity communication unit 707 transmits a beacon signal in which the 10-byte value indicating the business entity ID stored in the memory 702 is set as the namespace ID and the 6-byte value indicating the vending machine ID stored in the memory 702 is set as the instance ID.

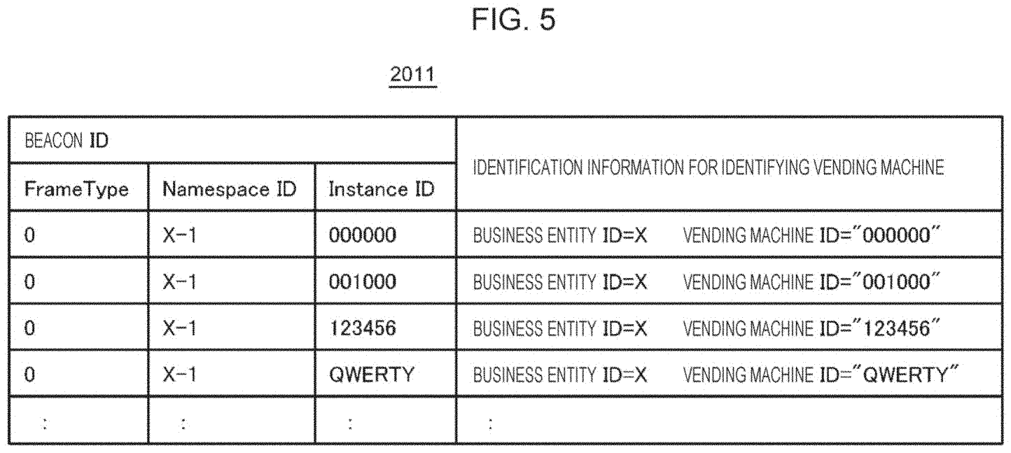

FIG. 5 is a diagram illustrating an example of a table indicating a relationship between a beacon ID and identification information of the vending machine 700. In this case, when the business entity X application is installed, a table 2011 indicating a relationship between a beacon ID and identification information of the vending machine 700 illustrated in FIG. 5 is stored in the memory 102 of the communication terminal 100. In response to receipt of a beacon signal, the proximity communication unit 107 of the communication terminal 100 refers to the table 2011 stored in the memory 102 to acquire identification information for identifying the vending machine 700 associated with the beacon ID included in the received beacon signal.

For example, the namespace ID and the instance ID of the beacon ID included in the beacon signal received by the proximity communication unit 107 are “X-1” and “000000”, respectively. In this case, the proximity communication unit 107 refers to the table 2011 illustrated in FIG. 5 to acquire identification information of the vending machine 700 which is “business entity ID=X vending machine ID=000000”.

### Process of Short-Range Wireless Communication Using Beacon Signal

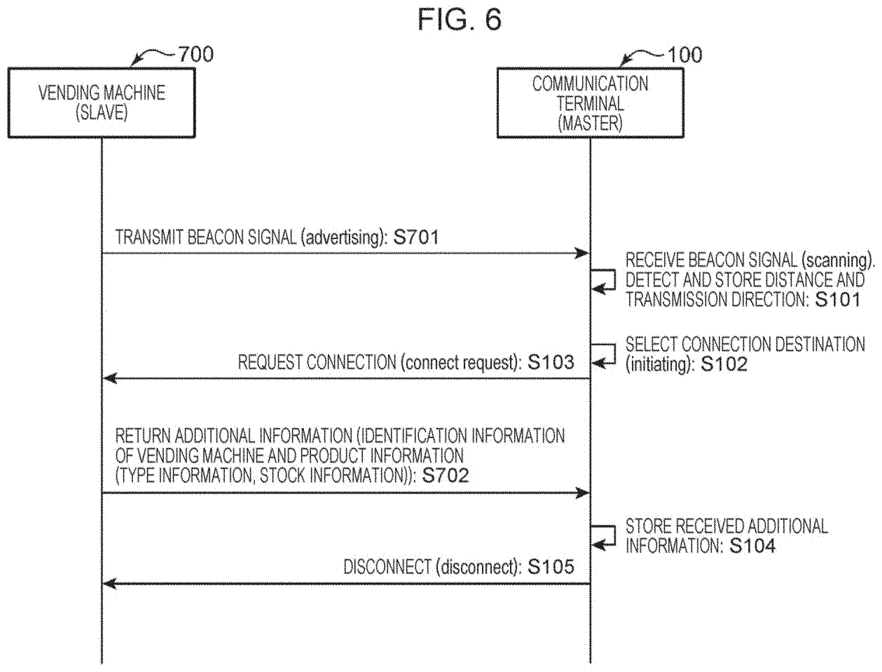

A process of short-range wireless communication using a beacon signal performed between the communication terminal 100 and the vending machine 700 will be described next with reference to FIG. 6. FIG. 6 is a sequence diagram illustrating a process of short-range wireless communication using a beacon signal.

In short-range wireless communication using a beacon signal performed between the communication terminal 100 and the vending machine 700, the proximity communication unit 707 of the vending machine 700 operates as a slave and the proximity communication unit 107 of the communication terminal 100 operates as a master.

Specifically, as illustrated in FIG. 6, the proximity communication unit 707 of the vending machine 700 periodically transmits a beacon signal (advertising) (step S701).

In response to receipt of the beacon signal (scanning), the proximity communication unit 107 of the communication terminal 100 detects a distance to the vending machine 700 that is the transmission source of the beacon signal and a transmission direction of the beacon signal as well as the beacon ID. The proximity communication unit 107 notifies the computation unit 104 of receipt of the beacon signal, and outputs information indicating the detected distance and transmission direction to the computation unit 104. Thus, in response to detection of the receipt of the beacon signal by the proximity communication unit 107, the computation unit 104 stores the information received from the proximity communication unit 107 in the memory 102 (step S101). Specifically, in step S101, the proximity communication unit 107 detects the transmission direction of the received beacon signal, based on specifications defined by Bluetooth (registered trademark) 5.1, for example.

The proximity communication unit 107 of the communication terminal 100 then selects the proximity communication unit 707 of the vending machine 700 identified by the beacon ID included in the beacon signal, as a connection destination (initiating) (step S102). The proximity communication unit 107 then sends a signal indicating a connection request (connect request) to the selected proximity communication unit 707 of the vending machine 700 (step S103).

In response to receipt of the signal indicating the connection request, the proximity communication unit 707 of the vending machine 700 establishes a connection to the communication terminal 100 that has sent the signal indicating the connection request, and notifies the computation unit 704 of the receipt. In response to this notification, the computation unit 704 controls the product detection unit 708 to read identification information for identifying the vending machine 700 and product information including type information and stock information from the memory 702. Hereinafter, for convenience of explanation, the identification information for identifying the vending machine 700 may be referred to as identification information of the vending machine 700. Under the control of the computation unit 704, the proximity communication unit 107 returns, as additional information, the identification information of the vending machines 700 and the product information that are read by the computation unit 704, to the proximity communication unit 107 of the communication terminal 100 that has sent the signal indicating the connection request (step S702). The identification information of the vending machine 700 and the product information are returned to the communication terminal 100 as the additional information in this example. However, the identification information is not necessarily sent because the vending machine 700 that is the connection destination is known at the time of connection.

In response to receipt of the additional information, the proximity communication unit 107 of the communication terminal 100 outputs the received additional information to the computation unit 104. The computation unit 104 stores the additional information received from the proximity communication unit 107 in the memory 102 (step S104). The proximity communication unit 107 then returns a signal indicating disconnection (disconnect) (step S105).

Thus, the proximity communication unit 107 of the communication terminal 100 ends the communication with the proximity communication unit 707. The proximity communication unit 707 of the vending machine 700 disconnects the connection with the proximity communication unit 107 of the communication terminal 100. The proximity communication unit 107 of the communication terminal 100 then returns to a state of waiting for receipt of a beacon signal transmitted from the proximity communication unit 707 of another vending machine 700.

Thereafter, each time the proximity communication unit 107 of the communication terminal 100 receives a beacon signal transmitted from the proximity communication unit 707 of another vending machine 700, processing of step S101 and subsequent steps is repeated if the product information of the vending machine 700 that has transmitted the beacon signal has not been acquired yet or if a predetermined time or more has elapsed since acquisition of the product information of the vending machine 700 that has transmitted the beacon signal. Thus, the computation unit 104 acquires, from each vending machine 700 located within a beacon signal receivable range, the identification information and the product information of the vending machine 700. The computation unit 104 also acquires, from the memory 102, information indicating a distance to each vending machine 700 which is the transmission source of a corresponding beacon signal received by the proximity communication unit 107 and a transmission direction of the beacon signal.

### First Embodiment

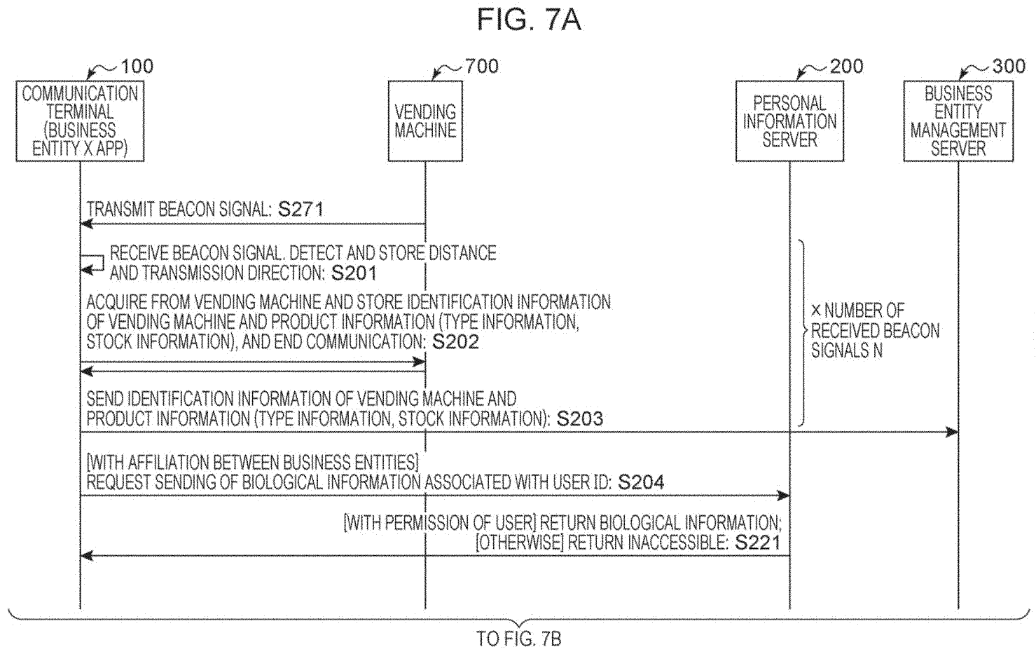

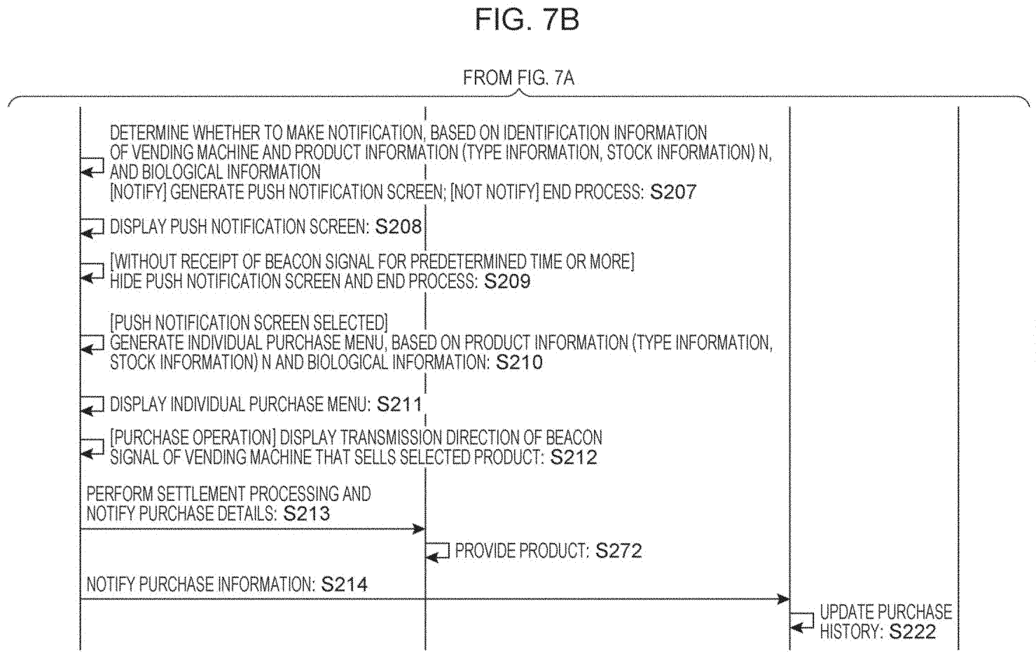

An overview of a process performed in the vending machine management system in a first embodiment of the present disclosure will be described next with reference to FIGS. 7A and 7B. FIGS. 7A and 7B are a sequence diagram illustrating an example of the overview of the process performed in the vending machine management system in the first embodiment.

As illustrated in FIG. 7A, the proximity communication unit 707 of each of the vending machines 700 included in the vending machine management system periodically transmits a beacon signal (step S271). This processing corresponds to step S701 illustrated in FIG. 6.

The business entity X application is executed in the communication terminal 100 in the foreground or background, so that the proximity communication unit 107 enters a state of waiting for receipt of a beacon signal. Consequently, the processing of step S101 and subsequent steps illustrated in FIG. 6 is performed. Specifically, in response to receipt of the beacon signal transmitted in step S271, the proximity communication unit 107 detects a distance to a transmission source of the beacon signal (which is the vending machine 700) and a transmission direction of the beacon signal as well as the beacon ID. The proximity communication unit 107 then notifies the computation unit 104 of the receipt of the beacon signal and outputs information indicating the detected beacon ID, distance, and transmission direction to the computation unit 104. Thus, in response to detection of the receipt of the beacon signal by the proximity communication unit 107, the computation unit 104 stores the information indicating the beacon ID, the distance, and the transmission direction acquired from the proximity communication unit 107 in the memory 102 (step S201). This processing corresponds to step S101 illustrated in FIG. 6.

Processing corresponding to the processing of step S102 and subsequent steps illustrated in FIG. 6 is performed next. Specifically, the proximity communication unit 107 of the communication terminal 100 performs short-range wireless communication with the proximity communication unit 707 of the vending machine 700 which is the transmission source of the beacon signal received in step S201. Thus, the proximity communication unit 107 acquires additional information that includes identification information for identifying the vending machine 700 and product information including type information and stock information. The proximity communication unit 107 outputs the acquired additional information to the computation unit 104, and ends the communication with the proximity communication unit 707 of the vending machine 700. The computation unit 104 stores the additional information acquired from the proximity communication unit 107 in the memory 102 (step S202).

The computation unit 104 then controls the communication unit 101 to send the identification information of the vending machine 700 and the product information that are acquired in step S202 to the business entity management server 300 (step S203). In response to this, in the business entity management server 300, based on the identification information of the vending machine 700 and the product information that are acquired via the communication unit 301, the computation unit 302 updates product information of the vending machine 700 corresponding to the identification information and stored in the memory 303.

In this way, each time the proximity communication unit 107 of the communication terminal 100 receives a beacon signal transmitted from the proximity communication unit 707 of the vending machine 700 from which the product information has not been acquired yet, the processing from step S201 to step S203 is repeated in response to the receipt.

In response to detecting that a plurality of beacon signals transmitted from the plurality of vending machines 700 are received by the proximity communication unit 107, the computation unit 104 may perform merely steps S201 and S202 at receipt of each of the beacon signals by the proximity communication unit 107 and may perform step S203 just once (or the number of times less than the number of iterations of step S202). Thus, the computation unit 104 may collectively send the pieces of identification information and the pieces of product information of the respective vending machines 700 acquired in each step S202 to the business entity management server 300 in single step S203.

Suppose that the business entity (business operator) X application or the business entity X that provides the business entity X application has an affiliation with the managing business entity (management operator) of the personal information server 200 and that the business entity X application is permitted to acquire personal information of each user stored in the personal information server 200. In this case ([with affiliation between business entities]), the computation unit 104 of the communication terminal 100 controls the communication unit 101 to send, to the personal information server 200, identification information (first identification information) for identifying the communication terminal 100 stored in the memory 102 and a signal requesting sending of biological information of the user identified by the user ID included in the identification information (step S204).

In the personal information server 200, in response to the communication unit 201 receiving the identification information (including the user ID for identifying the user) for identifying the communication terminal 100 and the signal requesting sending of the biological information of the user, which are sent in step S204, the computation unit 202 performs processing of step S221 (step S221).

Specifically, in step S221, the computation unit 202 determines whether the user indicated by the user ID included in the identification information received by the communication unit 201 is a user with permission. If the computation unit 202 determines that the user is a user with permission ([with permission of user]), the computation unit 202 acquires the biological information included in the personal information of the user with permission from the memory 203 and causes the communication unit 201 to return the acquired biological information. On the other hand, if the computation unit 202 determines that the user is not a user with permission ([otherwise]), the computation unit 202 causes the communication unit 201 to return information indicating that the personal information is inaccessible. The returned information is received and output to the computation unit 104 by the communication unit 101 of the communication terminal 100.

If the computation unit 202 determines that the user is not a user with permission ([otherwise]), the computation unit 202 may cause the communication unit 201 to return a message for checking whether to permit reading of the personal information stored in the memory 203. Suppose that in response to this, the computation unit 202 acquires a reply indicating permission from the communication terminal 100 via the communication unit 201. In this case, the computation unit 202 may acquire, from the memory 203, the biological information included in the personal information of the user indicated by the user ID included in the received identification information, and cause the communication unit 201 to return the acquired information in step S221.

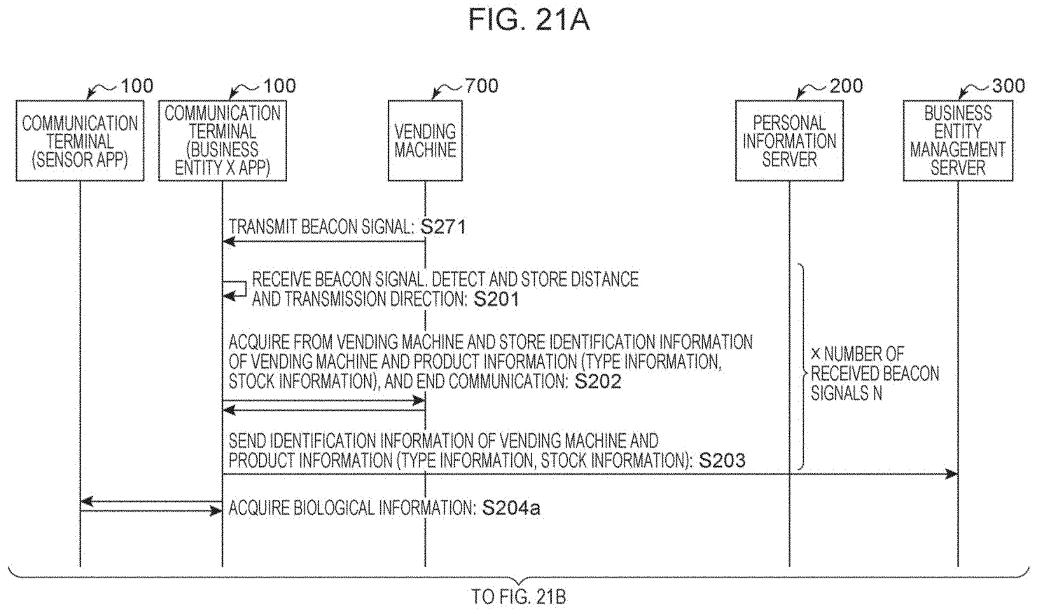

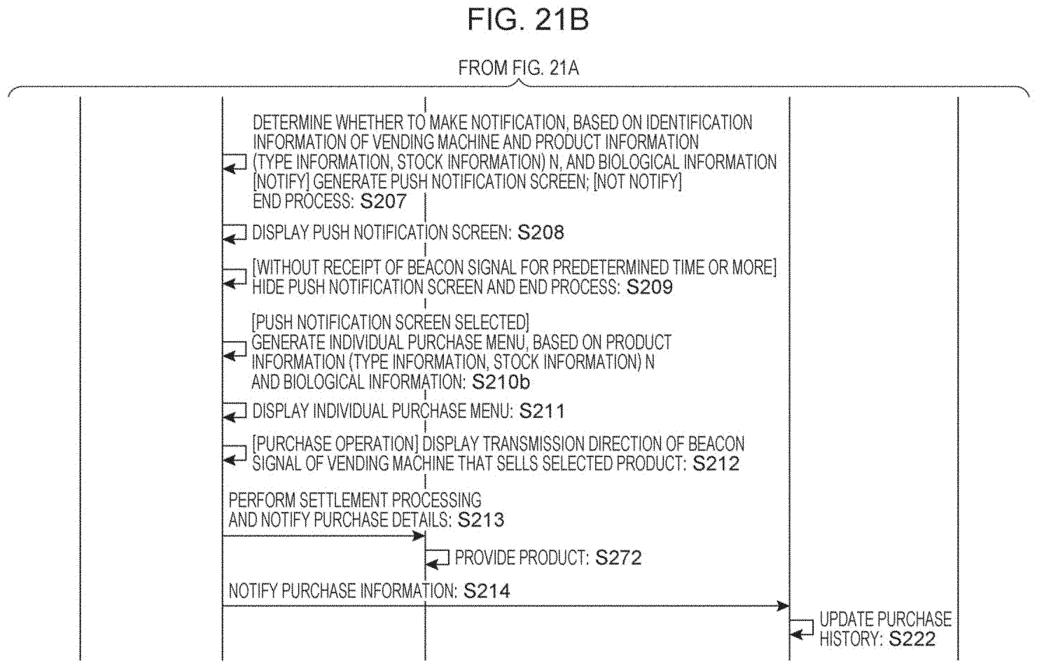

If the biological information of the user of the communication terminal 100 is stored in the memory 102 of the communication terminal 100, the computation unit 104 further acquires the biological information of the user in a range not overlapping the biological information returned in step S221. There is a possibility that the latest biological information is sent from the biological sensor 600 to the communication terminal 100 and is accumulated and managed by the sensor application but is not uploaded to the personal information server 200 yet. Since the drink determination process (described below) is performed also using the latest biological information, the latest biological information stored in the memory 102 of the communication terminal 100 in this manner may be acquired additionally as indicated in step S204a in FIG. 21A.

The computation unit 104 then performs step S207 (step S207). In step S207, the computation unit 104 first determines whether to make notification by the push notification screen, based on each combination of the identification information of the vending machines 700 and the type information and the stock information included in the product information and the biological information that are acquired in the preceding steps. Each combination of the identification information of the vending machines 700 and the type information and the stock information included in the product information is the combination acquired in step S202 each time a beacon signal is received. The biological information is the biological information returned and acquired via the communication unit 101 in step S221 and the biological information acquired by the business entity X application from the sensor application in the communication terminal 100 as illustrated in step S204a of FIG. 21A. Details of the determination method will be described later.

If the computation unit 104 determines to make notification by the push notification screen ([notify]), the computation unit 104 generates the push notification screen based on each combination of the identification information of the vending machines 700 and the type information and the stock information included in the product information and the biological information that are used in the determination. On the other hand, if the computation unit 104 determines not to make notification by the push notification screen ([not notify]), the computation unit 104 ends the process. After ending the process, the computation unit 104 returns to a state of waiting for receipt of a beacon signal by the proximity communication unit 107 similarly to immediately after the start of execution of the business entity X application.

If the push notification screen is generated in step S207, the computation unit 104 then displays the generated push notification screen on the display 105 of the communication terminal 100 (step S208). The computation unit 104 may display the push notification screen on the display 105 and may also drive a vibration generator (not illustrated) built in the communication terminal 100 to allow the user of the communication terminal 100 to easily notice the push notification. The computation unit 104 may display the push notification screen on the display 105 and may also reproduce a sound reporting receipt of the push notification from a speaker (not illustrated) built in the communication terminal 100 to allow the user of the communication terminal 100 to easily notice the push notification. These may be used in combination.

Only when it is determined that the risk of heatstroke of the user is higher than a predetermined value based on the biological information of the user including one or more of the body temperature, the body water percentage, the heart rate, the blood pressure, and the amount of perspiration of the user, the computation unit 104 may display the push notification screen on the display 105 and vibrate the communication terminal 100 and/or reproduce the sound from the communication terminal 100. Thus, it is possible to more reliably make the user aware of the push notification that reports the risk of heatstroke.

As described above, in response to receipt of a beacon signal by the proximity communication unit 107, the communication terminal 100 performs the processing of step S201 and subsequent steps, so that the push notification screen is automatically displayed in step S208.

If receipt of a beacon signal by the proximity communication unit 107 is not detected for a predetermined time or more since the push notification screen is displayed in step S208 ([without receipt of beacon signal for predetermined time or more]), the computation unit 104 performs processing of hiding the displayed push notification screen to hide the push notification screen. The computation unit 104 then ends the process (step S209). After ending the process, the computation unit 104 returns to a state of waiting for receipt of a beacon signal by the proximity communication unit 107.

On the other hand, if the user performs an operation (for example, a touch operation) of selecting the push notification screen by using the operation unit 106 ([push notification screen selected]), the computation unit 104 generates an individual purchase menu for preventing heatstroke, based on the type information and the stock information included in the product information and the biological information that are used in step S207 (step S210).

The computation unit 104 then displays the individual purchase menu generated in step S210 on the display 105 of the communication terminal 100 (step S211).

Suppose that the user of the communication terminal 100 then selects a drink to be purchased from among drinks included in the individual purchase menu displayed in step S211 and performs a purchase operation of the selected drink, by using the operation unit 106. In this case ([purchase operation]), the computation unit 104 reads, from the memory 102, information indicating the transmission direction of the beacon signal transmitted by the vending machine 700 that sells the drink selected as the drink to be purchased. The computation unit 104 displays a direction indication indicating the transmission direction of the beacon signal indicated by the read information on the display 105 of the communication terminal 100 (step S212). After the drink to be purchased is confirmed, the computation unit 104 may re-scan the beacon signal transmitted by the proximity communication unit 707 of the vending machine 700 storing the drink, and display a direction indication indicating the transmission direction of the beacon signal on the display 105 of the communication terminal 100.

The user of the communication terminal 100 then moves to the vending machine 700 that sells the drink to be purchased and performs a predetermined payment operation using the communication terminal 100. In response to the payment operation, the computation unit 104 performs predetermined settlement processing and controls the proximity communication unit 107 to send information indicating drink purchase details to the vending machine 700 (step S213). The information indicating the drink purchase details includes, for example, a product name of the purchased drink, a quantity of purchase of the drink, and a total amount required to purchase the drink.

In the predetermined settlement processing, for example, the computation unit 104 subtracts an amount equivalent to the total amount required to purchase the drink from electronic money balance data stored in the memory 102. The computation unit 104 also controls the proximity communication unit 107 to send electronic money corresponding to the total amount required to purchase the drink, to the vending machine 700 that sells the drink selected as the drink to be purchased.

Alternatively, in the predetermined settlement processing, the computation unit 104 may control the communication unit 101 to send information indicating the drink purchase details and information on a credit card or electronic money input through the payment operation or stored in advance in the memory 102 to the business entity management server 300 that manages the vending machine 700 that sells the drink selected as the drink to be purchased or a server (not illustrated) of an electronic money settlement entity, and request the business entity management server 300 to perform the settlement processing according to the purchase details.

Alternatively, in the predetermined settlement processing, the computation unit 104 may control the proximity communication unit 107 to send information indicating the drink purchase details and information on a credit card input through the payment operation or stored in advance in the memory 102 to the vending machine 700 that sells the drink selected as the drink to be purchased, and request the vending machine 700 to perform the settlement processing according to the purchase details.

In the vending machine 700, according to the information indicating the drink purchase details sent in step S213 and acquired via the proximity communication unit 707, the computation unit 704 causes the drink having the product name indicated by the information to be transported to the pick-up port as many times as the quantity of purchase indicated by the information. Consequently, the drink purchased by the user is provided to the user (step S272).

After step S213, the computation unit 104 of the communication terminal 100 controls the communication unit 101 to send the purchase information of the drink to the personal information server 200 (step S214). The purchase information of the drink includes the user ID of the user of the communication terminal 100, the date and time information indicating the purchase date and time of the drink by the user, the identification information for identifying the vending machine 700 from which the user purchased the drink, and the type information indicating the type of the drink purchased by the user.

In the personal information server 200, in response to the communication unit 201 receiving the purchase information sent in step S214, if the user indicated by the user ID included in the purchase information received by the communication unit 201 is a user with permission, the computation unit 202 updates the purchase history information of the user with permission stored in the memory 203 based on the purchase information (step

### Method of Recommending and Purchasing Drink

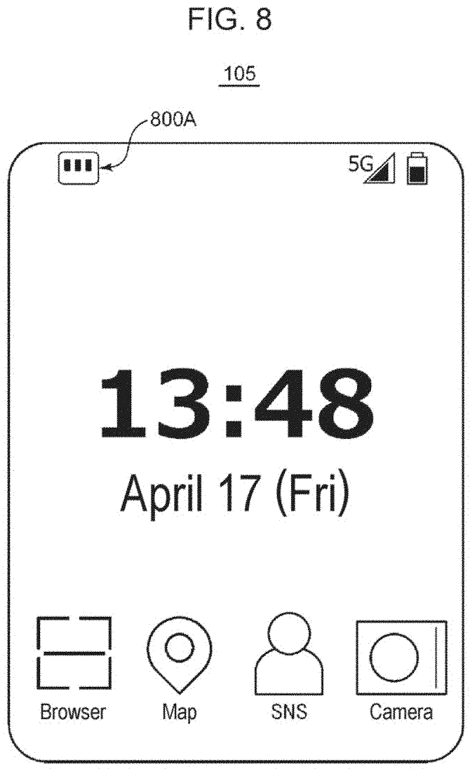

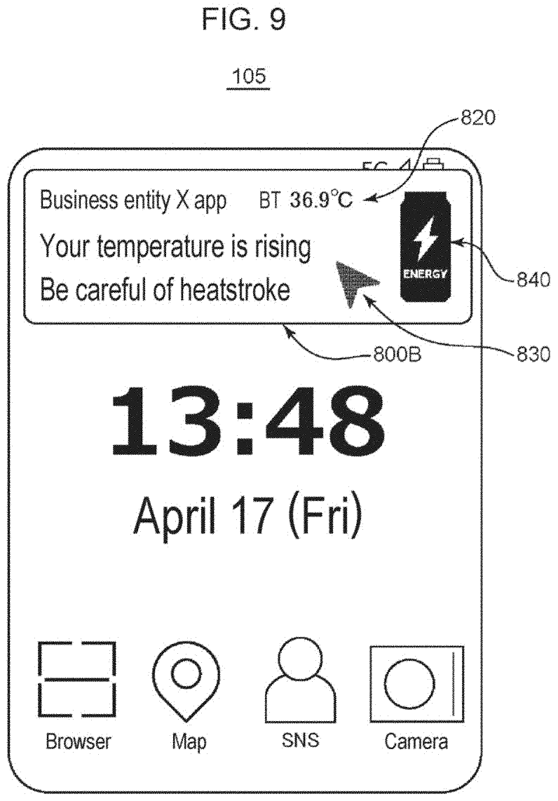

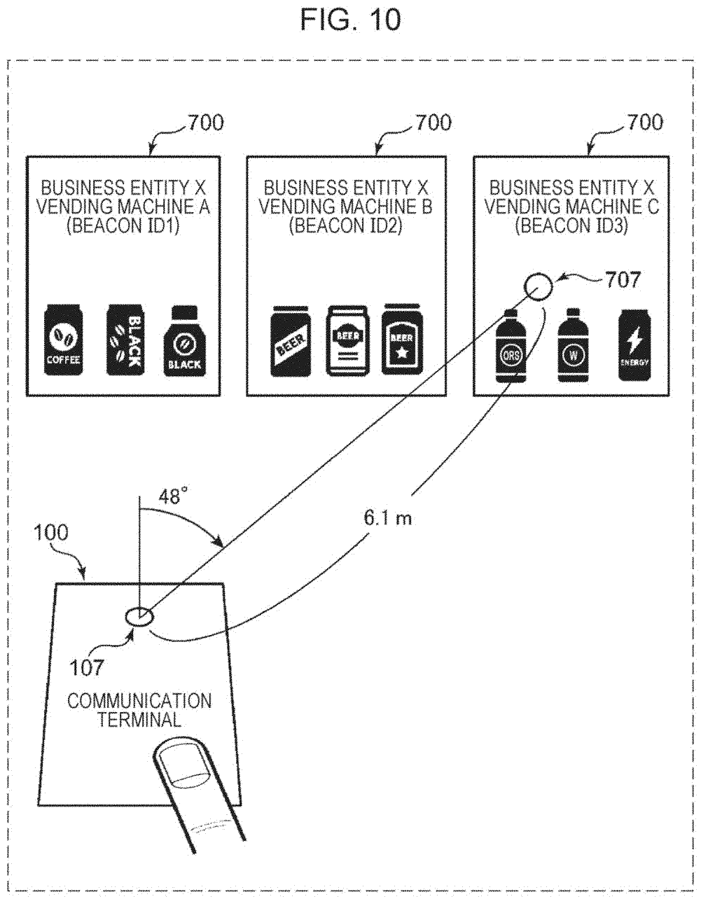

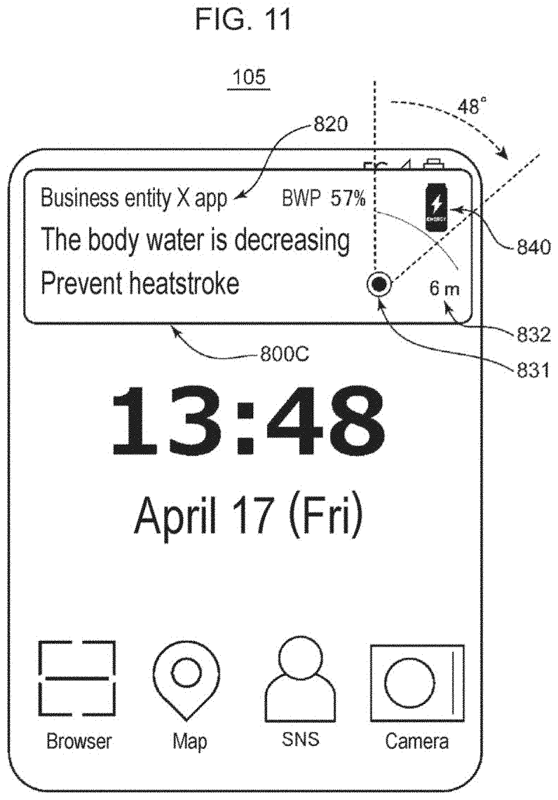

A method of recommending a drink to the user of the communication terminal 100 and a method of allowing the user to purchase a drink will be described below with reference to each processing (FIGS. 7A and 7B) performed in the vending machine management system described above. In the description, details of the push notification screen and the individual purchase menu will be described. FIG. 8 is a diagram illustrating a display example of a push notification screen 800A. FIG. 9 is a diagram illustrating a display example of a push notification screen 800B. FIG. 10 is a diagram illustrating an example of a relationship between a location of the communication terminal 100 and a location of the vending machine 700. FIG. 11 is a diagram illustrating a display example of a push notification screen 800C.

Suppose that after launching the business entity X application installed on the communication terminal 100 (including when the business entity X application is running in the background), the user carrying the communication terminal 100 passes in front of or is near the vending machine 700 managed by the business entity X. In this case, the communication terminal 100 receives a beacon signal transmitted from the vending machine 700, and performs the processing from step S201 to step S207 illustrated in FIGS. 7A and 7B. In step S207, the push notification screen is generated if it is determined to make notification by the push notification screen, and step S208 (FIG. 7B) is performed. Consequently, the push notification screen is displayed on the display 105.

Specifically, in step S208, the computation unit 104 displays the push notification screen 800A imitating the vending machine 700 at an uppermost portion of the display 105 of the communication terminal 100 as illustrated in FIG. 8, for example.

In response to the user performing an operation of sliding the push notification screen 800A downward with a finger or an operation of touching (selecting) the push notification screen 800A with a finger, the computation unit 104 displays the detailed push notification screen 800B on the display 105 as illustrated in FIG. 9. In step S208, the computation unit 104 may display the detailed push notification screen 800B illustrated in FIG. 9 on the display 105 without displaying the push notification screen 800A illustrated in FIG. 8.

The push notification screen 800B includes a message 820 and an icon image 840. The message 820 is a message that recommends one drink that is suitable for hydrating the user of the communication terminal 100 to prevent heatstroke and is determined from among a plurality of drinks stored in the vending machines 700 that are the transmission sources of the respective beacon signals and are indicated by the respective pieces of identification information acquired in step S202 (FIG. 7A) each time a beacon signal is received.

Specifically, the message 820 includes biological information (for example, “BT 36.9° C.”) of the user of the communication terminal 100 used to determine the one drink. The message 820 also includes a recommendation message (for example, “Your temperature is rising. Be careful of heatstroke”) that is determined according to the kind (for example, body temperature) of the biological information used to determine the one drink and that draws attention to heatstroke. The recommendation message is stored in advance in the memory 102 in association with the kind of the biological information.

The icon image 840 is an image representing the one drink. In this manner, a drink suitable for hydrating the user of the communication terminal 100 to prevent heatstroke is recommended to the user who is in the vicinity of the vending machine 700.

In the push notification screen 800B, an image 830 is displayed as a direction indication indicating the transmission direction of the beacon signal transmitted by the vending machine 700 storing the recommended drink, based on the information indicating the transmission direction of the beacon signal stored in the memory 102 in step S201 (FIG. 7A). Thus, the user of the communication terminal 100 can grasp the direction in which the vending machine 700 storing the recommended drink is present.

In the push notification screen 800B, a message may be displayed that recommends a plurality of drinks that are suitable for hydrating the user of the communication terminal 100 to prevent heatstroke and are determined from among the plurality of drinks stored in the vending machines 700 that are the transmission sources of the respective beacon signals. Similarly to the image 830, direction indications each indicating the transmission direction of the beacon signal transmitted by a corresponding one of the vending machines 700 storing the plurality of recommended drinks may be displayed in the push notification screen 800B based on the information indicating the transmission directions of the beacon signals stored in the memory 102 in step S201 (FIG. 7A.

Alternatively, suppose that the proximity communication unit 107 of the communication terminal 100 receives a beacon signal transmitted by the proximity communication unit 707 of the vending machine 700 located at a location that is 6.1 m away from the proximity communication unit 107 in a direction rotated clockwise by 48 degrees from the front direction of the communication terminal 100, as illustrated in FIG. 10, for example. In this case, the computation unit 104 may generate the push notification screen 800C illustrated in FIG. 11 and display the push notification screen 800C on the display 105.

The push notification screen 800C includes the message 820 identical to that in the push notification screen 800B illustrated in FIG. 9. In the push notification screen 800C illustrated in FIG. 11, an image different from the image 830 illustrated in FIG. 9 is displayed as the direction indication.

Specifically, the computation unit 104 displays an image 831 indicating the current location of the communication terminal 100 and displays the icon image 840 indicating the product recommended in step S207 in a direction rotated clockwise by 48 degrees from the front direction of the image 831, by using the information indicating the transmission direction of the beacon signal stored in the memory 102 in step S201 (FIG. 7A). The computation unit 104 further displays an image 832 indicating the distance from the current location of the communication terminal 100 by using the information indicating the distance to the vending machine 700 that is the transmission source of the beacon signal stored in the memory 102 in step S201 (FIG. 7A). In this specific example, since the distance to the vending machine 700 that is the transmission source of the beacon signal is 6.1 m (FIG. 10), the computation unit 104 displays the image 832 representing a distance of 6 m from the current location of the communication terminal 100, which is a rough indication of the distance, as illustrated in FIG. 11.

Hereinafter, the push notification screens 800A to 800C described above are collectively referred to as the push notification screen 800. Suppose that after the push notification screen 800 is displayed on the display 105, the user of the communication terminal 100 moves and a predetermined time or more has elapsed during which the proximity communication unit 107 of the communication terminal 100 fails to receive the beacon signal from the vending machine 700. In this case, step S209 (FIG. 7B) is performed, and the push notification screen 800 is hidden. Thus, the push notification screen 800 that recommends a drink being kept uselessly displayed on the display 105 of the communication terminal 100 of the user who presumably does not wish to purchase the drink is avoided.

However, the trigger of hiding the push notification screen 800 is not limited to this. When the user of the communication terminal 100 performs, using the operation unit 106, an operation (for example, a swipe operation) in an area of the display 105 where the push notification screen 800 is displayed, the computation unit 104 may perform the processing of hiding the displayed push notification screen 800 to hide the push notification screen 800. Alternatively, when the user does not perform any operation on the push notification screen 800 for a predetermined time or more since the display of the push notification screen 800, the computation unit 104 performs the processing of hiding the displayed push notification screen 800 to hide the push notification screen 800, or the computation unit 104 may perform processing of displaying an indication such as “timeout” over the push notification screen 800 to invalidate the push notification screen 800.

The user who wishes to purchase a drink after viewing the push notification screen 800 performs an operation (for example, a touch operation) of selecting the push notification screen 800 by using the operation unit 106. In this case, steps S210 and S211 (FIG. 7B) are performed. Consequently, the individual purchase menu is displayed on the display 105.

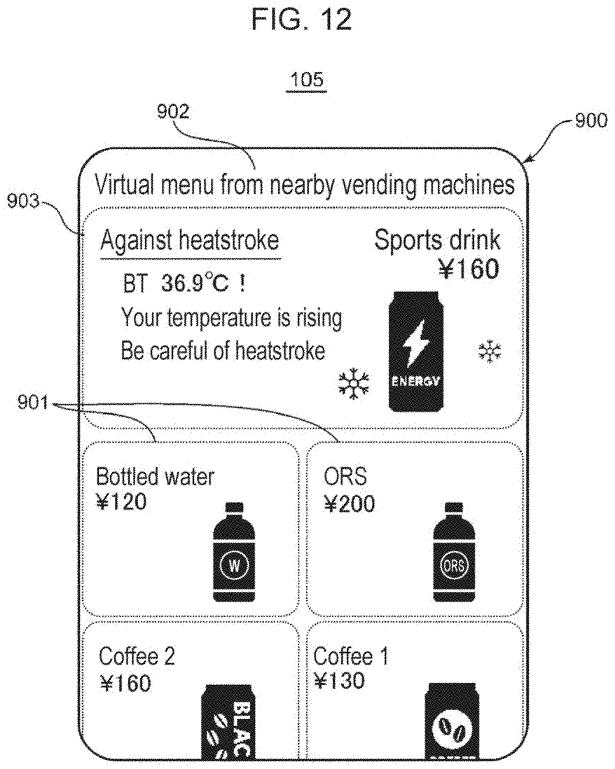

FIG. 12 is a diagram illustrating a display example of an individual purchase menu 900. Specifically, in step S211 (FIG. 7B), the computation unit 104 displays the individual purchase menu 900 on the display 105 as illustrated in FIG. 12, for example. The individual purchase menu 900 includes a single large tile object 903, a plurality of tile objects 901 arranged in a matrix, and a title 902.

The single large tile object 903 corresponds to one drink recommended by the push notification screen 800. The large tile object 903 includes the message 820 displayed in the push notification screen 800, a product name of the drink, a price of the drink, and an image of the drink.

One tile object 901 corresponds to one drink that is different from the one drink corresponding to the single large tile object 903 among drinks that are suitable for hydrating the user of the communication terminal 100 to prevent heatstroke and are determined from among the plurality of drinks stored in the vending machines 700 that are transmission sources of the respective beacon signals and are indicated by the respective pieces of identification information acquired in step S202 (FIG. 7A) each time a beacon signal is received. Each of the tile objects 901 includes a product name of the drink, a price of the drink, and an image of the drink.

Similarly to the image 830 included in the push notification screen 800 illustrated in FIG. 9, for example, a direction indication indicating the transmission direction of the beacon signal transmitted by the corresponding vending machine 700 storing the drink may be displayed in the single large tile object 903 and each of the tile objects 901, based on the information indicating the transmission direction of the beacon signal stored in the memory 102 in step S201 (FIG. 7A).

The single large tile object 903 and the tile objects 901 are arranged according in order according to a suitable degree for hydrating the user of the communication terminal 100 to prevent heatstroke. For example, the single large tile object 903 corresponds to a drink having the highest ranking and is displayed at an uppermost portion. For example, the tile objects 901 are arranged from the left end to the right end sequentially from the tile object 901 corresponding to a drink that is different from the one drink corresponding to the single large tile object 903 but has the high ranking in the order below the single large tile object 903. After one of the tile objects 901 is arranged at the right end, the tile objects 901 are arranged from the left end to the right end in the next row below.

Suppose that there are a plurality of drinks with the highest ranking suitable for hydrating the user of the communication terminal 100 to prevent heatstroke. In this case, the individual purchase menu 900 may include a plurality of large tile objects 903 corresponding to the plurality of recommended drinks. In this case, the plurality of large tile objects 903 are arranged from an upper portion to the lower portion, and each tile object 901 is arranged from the row below.

The example of the individual purchase menu 900 of FIG. 12 indicates that drink with the product name “sports drink” indicated by the single large tile object 903 arranged in the uppermost row has the highest ranking. The example also indicates that a drink with the product name “bottled water” represented by the tile object 901 arranged at the left end below the large tile object 903 has the next highest ranking in the order, and a drink with the product name “coffee 1” represented by the tile object 901 arranged at the right end in the lowermost row has the lowest ranking in the order.

The arrangement order of the large tile object 903 and the tile objects 901 according to the rankings described herein is an example, and the present disclosure is not limited to this example. In accordance with the rankings in the order, the large tile object 903 and the tile objects 901 may be arranged from the right end to the left end in the same row, may be arranged from the lowermost row to the uppermost row, or may be arranged in a combination thereof.

For example, a plurality of objects representing a plurality of drinks may be arranged in a line horizontally, vertically, or on an arc line, and only some of the objects may be displayed on the display 105. In this case, the object representing the drink having the highest ranking in the order may be arranged to be displayed at the center initially, and the object representing the drink having the next highest ranking may be arranged to be displayed next to the object representing the drink having the highest ranking in the order. In this example, the objects may be arranged so that the ranking in the order becomes lower as the position becomes closer to the right, the objects may be arranged so that the ranking in the order becomes lower as the position becomes closer to the left, or the ranking of the drink represented by the object may become lower as the distance of the object from the object representing the drink having the highest ranking in the order increases.

As described above, the individual purchase menu 900 is not an individual purchase menu specific for one vending machine 700 but is a menu obtained by integrating, as one purchase menu, drinks that are determined to be suitable for hydrating the user of the communication terminal 100 to prevent heatstroke from among a plurality of drinks stored in all the vending machines 700 that are transmission sources of the beacon signals received by the communication terminal 100. Thus, the title 902 indicates that the individual purchase menu 900 is an integrated purchase menu of a plurality of drinks sold by the nearby vending machines 700, such as “virtual menu from nearby vending machines” illustrated in FIG. 12, for example.

In response to the user performing a scroll operation in the individual purchase menu 900 by using the operation unit 106, the displayed tile objects 901 are changed accordingly. Thus, the tile objects 901 corresponding to other drinks that are not displayed at a time are displayed. As described above, the user can browse the tile objects 901 corresponding to all the drinks included in the individual purchase menu 900 by performing a scroll operation.

The user who has decided on the drink to be purchased after viewing the individual purchase menu 900 performs a purchase operation for the drink to be purchased.

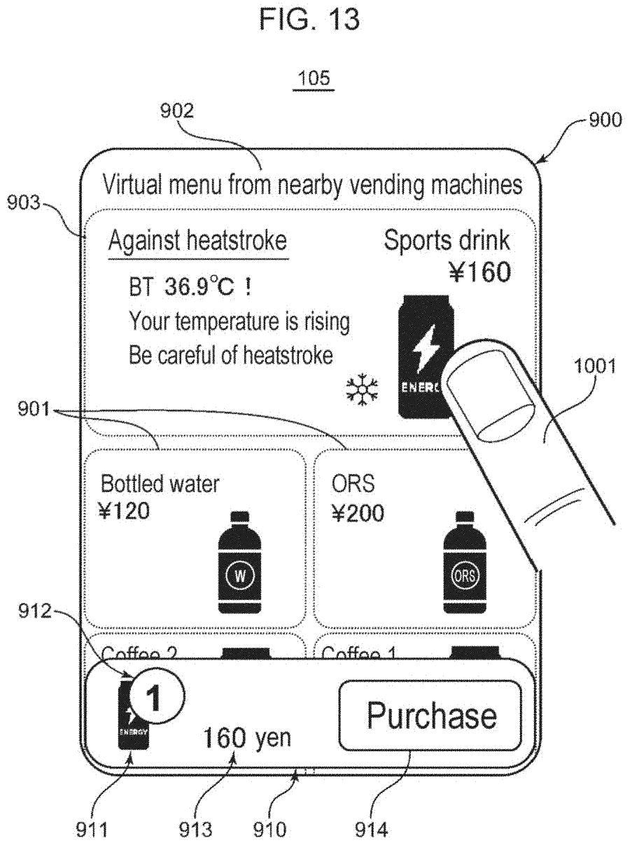

FIG. 13 is a diagram illustrating an example of a scene in which the user of the communication terminal 100 selects a drink to be purchased from the individual purchase menu 900. Specifically, as illustrated in FIG. 13, the user can select a drink to be purchased by performing a touch operation on the large tile object 903 or the tile object 901 representing the drink to be purchased by using a pointing body 1001 such as a finger.

When the large tile object 903 or the tile object 901 indicating the drink to be purchased is selected, the computation unit 104 changes a color and/or a pattern of the selected large tile object 903 or tile object 901 (hereinafter, referred to as a selected tile object). The computation unit 104 also displays “1” indicating the quantity of purchase of the drink represented by the selected tile object, at a predetermined position (for example, an upper right portion) of the selected tile object. Each time the tile large tile object 903 or the tile object 901 is selected by the user, the computation unit 104 counts up the quantity of purchase displayed over the selected tile object by one and displays the resulting quantity of purchase.

In response to at least one large tile object 903 or the tile object 901 being selected, the computation unit 104 displays a purchase operation screen 910 at, for example, a lowermost portion of the display 105. The purchase operation screen 910 includes an image 911 representing the drink to be purchased selected by the user, a quantity of purchase 912 of the drink to be purchased, a total amount 913 required to purchase as many drinks to be purchased as the quantity of purchase 912, and a purchase button 914 for confirming purchase of the drink. As described above, since the image of the drink to be purchased, the quantity of purchase, and the total amount required for purchase are displayed in the purchase operation screen 910, the user can efficiently check the purchase details.

In the purchase operation screen 910, a direction indication indicating the transmission direction of the beacon signal transmitted by the vending machine 700 storing the drink to be purchased may be displayed based on the information stored in the memory 102 in step S201 (FIG. 7A), similarly to the image 830 included in the push notification screen 800 illustrated in FIG. 9, for example.

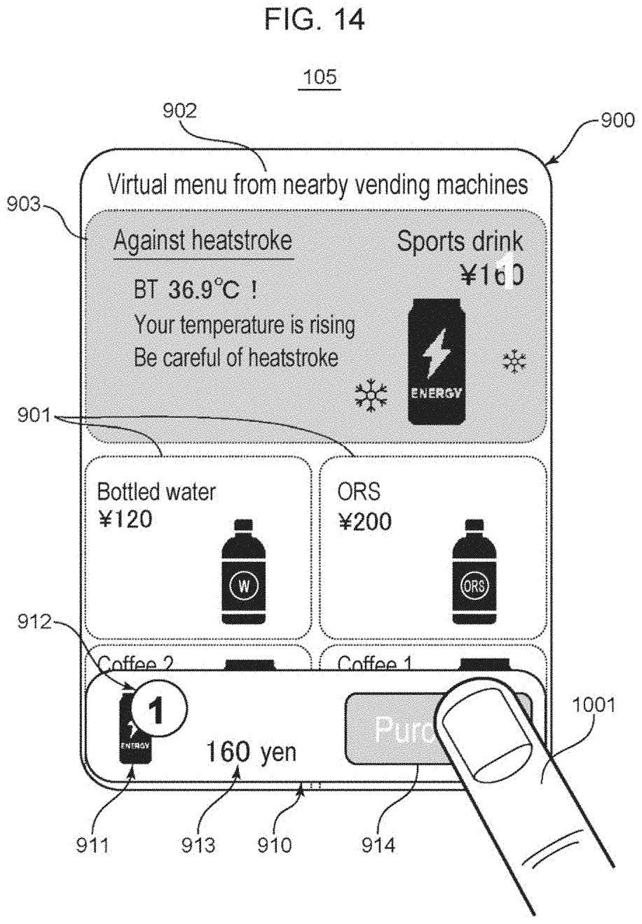

FIG. 14 is a diagram illustrating an example of a scene in which the user of the communication terminal 100 confirms purchase of the drink. As illustrated in FIG. 14, the user who has confirmed that there is no problem in the purchase details in the purchase operation screen 910 performs a touch operation on the purchase button 914 by using the pointing body 1001 such as a finger. While a touch operation on the purchase button 914 is continued, the computation unit 104 changes a color and/or a pattern of the purchase button 914.

When the user releases the pointing body 1001 from the purchase button 914, the purchase operation of the drink to be purchased is completed, and step S212 (FIG. 7B) is performed. Consequently, a direction indication indicating the transmission direction of the beacon signal transmitted by the vending machine 700 (hereinafter, referred to as a vending machine with the purchase target) that sells the drink selected as the drink to be purchased is displayed on the display 105.

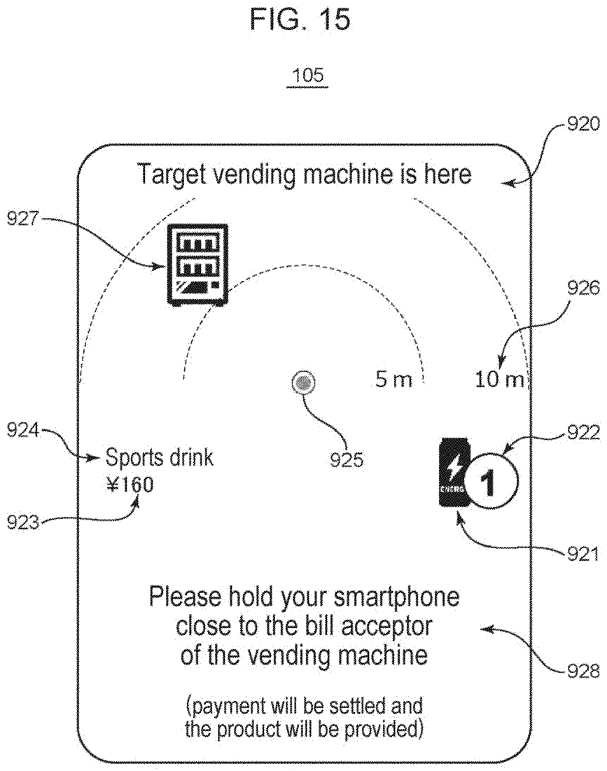

FIG. 15 is a diagram illustrating an example of a scene in which the user of the communication terminal 100 acquires the purchased drink. Specifically, in step S212, the computation unit 104 displays a payment guidance screen 920 for guiding a method for paying for the purchased drink on the display 105 as illustrated in FIG. 15.

As in the push notification screen 800C illustrated in FIG. 11, a direction indication indicating the transmission direction of the beacon signal transmitted by the vending machine with the purchase target is displayed in the payment guidance screen 920.

Specifically, the computation unit 104 displays an image 925 indicating the current location of the communication terminal 100. By using the information that indicates the transmission direction of the beacon signal transmitted by the vending machine with the purchase target and is stored in the memory 102 in step S201 (FIG. 7A) or by rescanning a beacon signal to update the transmission direction of the beacon signal transmitted by the vending machine with the purchase target, the computation unit 104 displays an icon image 927 representing the vending machine 700 in the transmission direction indicated by the information with respect to the front direction of the image 925.

The computation unit 104 also displays an image 926 indicating the distance from the current location of the communication terminal 100 by using the information that indicates the distance to the vending machine with the purchase target and is stored in the memory 102 in step S201 (FIG. 7A) or rescanning a beacon signal to update the information indicating the distance to (the proximity communication unit 707 of) the vending machine with the purchase target. Thus, the user can easily move to the vending machine with the purchase target by viewing the direction indication displayed in the payment guidance screen 920 to acquire the drink to be purchased.

The payment guidance screen 920 includes a type 924 of the drink to be purchased, an image 921 of the drink, a quantity of purchase 922 of the drink, and a total amount 923 required to purchase as many drinks to be purchased as the quantity of purchase 922. The payment guidance screen 920 also includes a message 928 for guiding a method of a payment operation performed using the communication terminal 100 at the vending machine with the purchase target.

The user moves to the vending machine with the purchase target while viewing the direction indication displayed in the payment guidance screen 920. In accordance with the message 928 displayed in the payment guidance screen 920, the user performs a payment operation at the vending machine with the purchase target by using the communication terminal 100. In response to the payment operation, step S213 (FIG. 7B) is performed in the communication terminal 100 and step S272 (FIG. 7B) is performed in the vending machine with the purchase target. Consequently, the drink purchased by the user is provided to the user.

As a result of step S214 (FIG. 7B) being performed, the purchase information of the drink is sent to the personal information server 200. Thus, step S222 (FIG. 7B) is performed. As a result, if the user of the communication terminal 100 is a user with permission, the purchase history information of the user stored in the memory 203 of the personal information server 200 is updated based on the purchase information sent in step S214.

### Data Configurations

Data configurations of the information used in each step illustrated in FIGS. 7A and 7B will be described next.

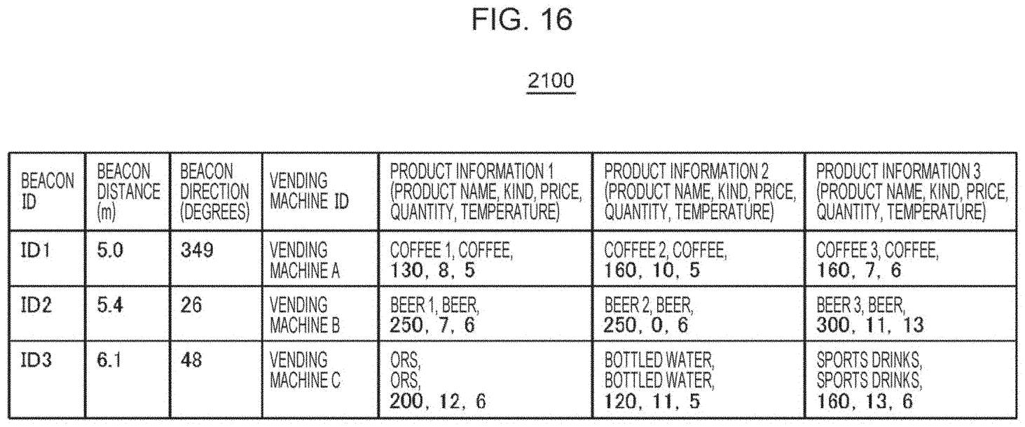

FIG. 16 is a diagram illustrating an example of a data configuration of information 2100 stored in the memory 102 of the communication terminal 100 at the time of receipt of a beacon signal. The information 2100 illustrated in FIG. 16 is stored in the memory 102 in steps S201 and S202.

A field “beacon ID” is a field indicating the beacon ID included in the beacon signal received in step S201 (see FIGS. 4 and 5 for the data structure of the beacon ID). A field “beacon distance” is a field indicating the distance from the communication terminal 100 to (the proximity communication unit 707 of) the vending machine 700 that is the transmission source of the beacon signal received in step S201. A field “beacon direction” is a field indicating the transmission direction of the beacon signal received in step S201.

A field “vending machine ID” is a field indicating the vending machine ID included in the identification information for identifying the vending machine 700, which is acquired in step S202 from the vending machine 700 that has transmitted the beacon signal received in step S201. Fields “product information 1” to “product information 3” are fields indicating pieces of product information, on respective drinks stored in the vending machines 700, which are included in the additional information acquired in step S202 from the vending machine 700 that has transmitted the beacon signal received in step S201.

For example, in step S201, a beacon signal with a beacon ID “ID1” is received. Thus, in a first record of the information 2100 illustrated in FIG. 16, “ID1” is stored in the field “beacon ID”. In step S201, the distance to the vending machine 700 that is the transmission source of the beacon signal is detected to be “5.0 (m)”, and the transmission direction of the beacon signal is also detected to be a direction rotated clockwise by “349 (degrees)” with respect to the front direction of the communication terminal 100 in a displayed map including the current location of the communication terminal 100. Thus, in the first record, “5.0” and “349” are stored in the fields “beacon distance” and “beacon direction”, respectively.

In next step S202, “vending machine A” is acquired as the vending machine ID from the vending machine 700 that is the transmission source of the beacon signal received in step S201. Thus, in the first record in FIG. 16, “vending machine A” is stored in the field “vending machine ID”.

Three types of drinks are stored in the vending machine 700. Product information including type information indicating that the product name is “coffee 1” and the kind is “coffee” and stock information indicating that the price is “130”, the quantity is “8”, and the temperature is “5”; product information including type information indicating that the product name is “coffee 2” and the kind is “coffee” and stock information indicating that the price is “160”, the quantity is “10”, and the temperature is “5”, and product information including type information indicating that the product name is “coffee 3” and the kind is “coffee” and stock information indicating that the price is “160”, the quantity is “7”, and the temperature is “6” are acquired from the vending machine 700. Thus, “coffee 1, coffee, 130, 8, 5”, “coffee 2, coffee, 160, 10, 5”, and “coffee 3, coffee, 160, 7, 6” are stored in the fields “product information 1”, “product information 2”, and “product information 3”, respectively.

The information 2100 illustrated in FIG. 16 further indicates that a record having the field “beacon ID” with “ID2” and a record having the field “beacon ID” with “ID3” are stored since beacon signals having the beacon IDs “ID2” and “ID3” are received, respectively.

For example, “vending machine B” (second identification information) is acquired as the vending machine ID from the vending machine 700 that is the transmission source of the beacon signal with the beacon ID “ID2”. Thus, “vending machine B” is stored in the field “vending machine ID” of the record in which the field “beacon ID” is “ID2”.

Three types of drinks are stored in the vending machine 700. Product information including type information indicating that the product name is “beer 1” and the kind is “beer” and stock information indicating that the price is “250”, the quantity is “7”, and the temperature is “6”; product information including type information indicating that the product name is “beer 2” and the kind is “beer” and stock information indicating that the price is “250”, the quantity is “0”, and the temperature is “6”; and product information including type information indicating that the product name is “beer 3” and the kind is “beer” and stock information indicating that the price is “300”, the quantity is “11”, and the temperature is “13” are acquired from the vending machine 700. Thus, “beer 1, beer, 250, 7, 6”, “beer 2, beer, 250, 0, 6”, and “beer 3, beer, 300, 11, 13” are stored in the fields “product information 1”, “product information 2”, and “product information 3”, respectively.

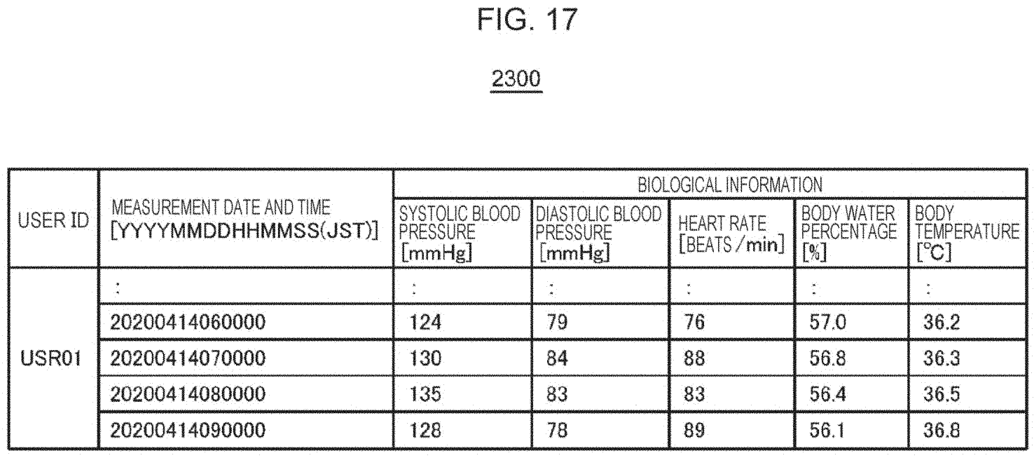

A data configuration of the biological information will be described next. FIG. 17 is a diagram illustrating an example of a biological information table 2300. As described above, the memory 203 of the personal information server 200 has the biological information table 2300 for storing the biological information collected from the biological sensor 600 by the sensor application in the communication terminal 100 in time series in association with the user ID of the user of the communication terminal 100 and the measurement date and time information indicating the measurement date and time of the biological information. There is a possibility that the most recent biological information in the biological information table 2300 is stored only in the memory 102 of the communication terminal 100. Thus, the latest biological information may be acquired from the communication terminal 100 instead of the personal information server 200.

In response to a request for the biological information of the user of the communication terminal 100 via the communication unit 201, the computation unit 202 of the personal information server 200 acquires a record including the user ID of the user from the biological information table 2300 illustrated in FIG. 17, and returns the acquired record as the biological information of the user.

A field “user ID” of the biological information table 2300 is a field indicating the user ID of the user of the communication terminal 100. A field “measurement date and time” is a field indicating the measurement date and time information. A “biological information” is a field indicating the biological information acquired from the communication terminal 100. The field “biological information” includes subfields “systolic blood pressure”, “diastolic blood pressure”, “heart rate”, “body water percentage”, and “body temperature” indicating the systolic blood pressure, the diastolic blood pressure, the heart rate, the body water percentage, and the body temperature of the user, respectively. The field “biological information” is not limited to this, and may include at least one or more of the fields “body water percentage” or “body temperature”.

For example, the biological information table 2300 illustrated in FIG. 17 presents an example in which pieces of biological information of the user having the user ID “USR01” measured every hour from 6:00:00 on Apr. 14, 2020 indicated by the measurement date and time information “20200414060000” to 9:00:00 on Apr. 14, 2020 indicated by the date and time information “20200414090000” are stored in time series.

For example, the biological information table 2300 illustrated in FIG. 17 presents an example in which the biological information of the user having the user ID “USR01”, which indicates that the systolic blood pressure, the diastolic blood pressure, the heart rate, the body water percentage, and the body temperature measured at 6:00:00 on Apr. 14, 2020 are “124 mmHg”, “79 mmHg”, “76 beats/min”, “57.0%”, and “36.2° C.” are stored in the fields “systolic blood pressure”, “diastolic blood pressure”, “heart rate”, “body water percentage”, and “body temperature” of a record in which the field “user ID” is “USR01” and the field “measurement date and time” is “20200414060000” which indicates 6:00:00 on Apr. 14, 2020, respectively.

### Process of Determining Drink Suitable for Hydrating User to Prevent Heatstroke

A drink determination process of determining at least one drink that is suitable for hydrating the user of the communication terminal 100 to prevent heatstroke, is recommended in the push notification screen 800, and is displayed in the individual purchase menu 900 will be described next by using a specific example. The drink determination process is performed when it is determined whether to make notification by the push notification screen 800, and a result of the drink determination process is used when the push notification screen 800 and the individual purchase menu 900 are generated.

In the present embodiment, in the drink determination process, at least one drink suitable for hydrating the user of the communication terminal 100 to prevent heatstroke is determined from among a plurality of drinks stored in the vending machines 700 that are transmission sources of respective beacon signals received by the proximity communication unit 107, by using each combination of the identification information of each of the vending machines 700 that are the transmission sources and the type information and the stock information included in the product information, and the biological information of the user of the communication terminal 100 that are acquired prior to the drink determination process.

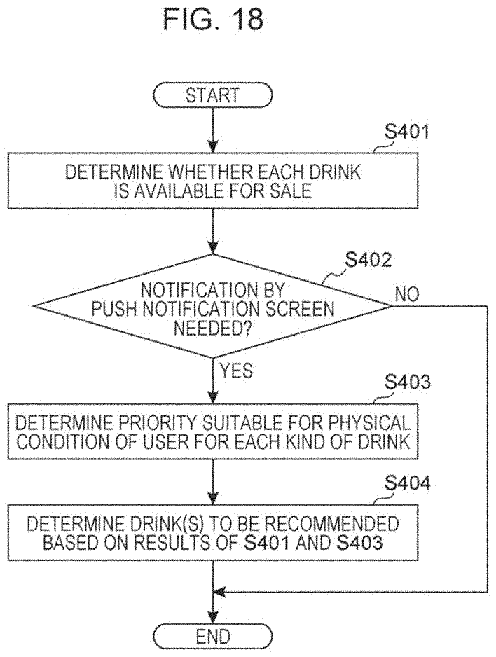

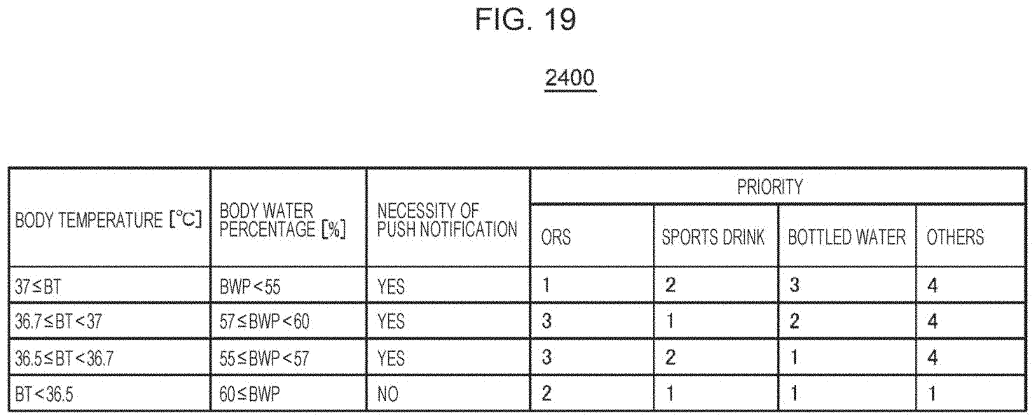

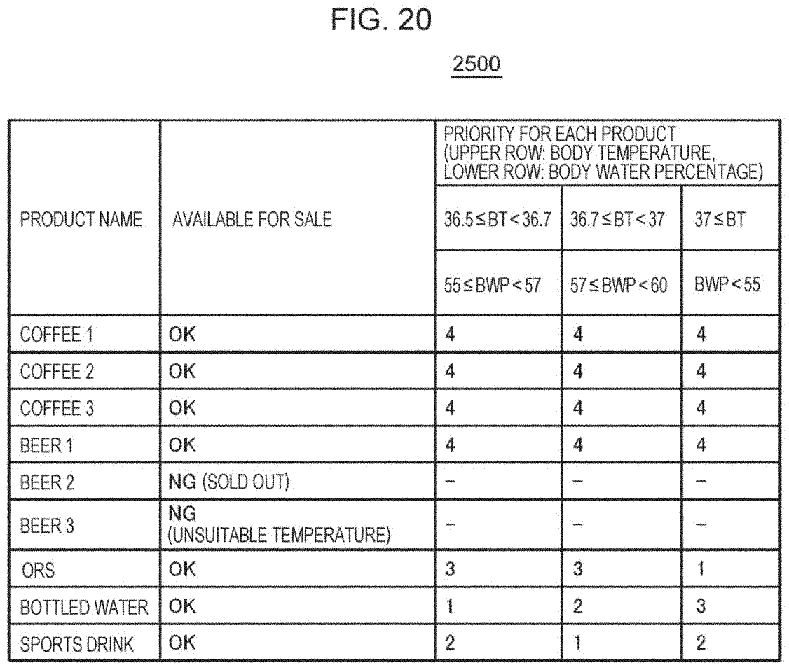

FIG. 18 is a flowchart illustrating an example of the drink determination process. FIG. 19 is a diagram illustrating an example of a determination table 2400 used in the drink determination process. FIG. 20 is a diagram illustrating an example of a work table 2500 used in the drink determination process illustrated in FIG. 18.

Suppose that in this specific example, the product information included in the information 2100 illustrated in FIG. 16 and one or more most recent records of the biological information table 2300 illustrated in FIG. 17 are acquired prior to the drink determination process.

As illustrated in FIG. 18, the computation unit 104 first refers to each piece of product information (FIG. 16) acquired prior to the drink determination process, and determines whether a drink corresponding to the piece of product information is available for sale based on the type information and the stock information included in the piece of product information. The computation unit 104 then stores a result of the determination in the work table 2500 illustrated in FIG. 20 (step S401). Thus, drinks determined to be not available for sale can be excluded from drinks recommended to the user.

Specifically, in step S401, the computation unit 104 determines that a drink corresponding to a piece of product information in which the quantity information included in the stock information indicates a quantity “0” is a drink that is sold out and thus is not available for sale. The computation unit 104 also determines that a drink corresponding to a piece of product information in which the temperature indicated by the temperature information included in the stock information is out of the predetermined temperature range in which the drink is providable to users is a drink that has an unsuitable temperature and thus is not available for sale. In this specific example, the predetermined temperature range for cold drinks is higher than or equal to 4° C. and lower than or equal to 7° C. In this specific example (FIG. 16), hot drinks are not handled. However, the predetermined temperature range for hot drinks is higher than or equal to 53° C. and lower than or equal to 57° C.

In the example of FIG. 16, in the record with the beacon ID “ID2”, the drink corresponding to the piece of product information in which the quantity indicated by the quantity information included in the stock information is “0” and the product name indicated by the product name information included in the type information is “beer 2” is determined to be a drink not available for sale. In the record with the beacon ID “ID2”, the drink corresponding to the piece of product information in which the temperature indicated by the temperature information included in the stock information is “13” and the product name indicated by the product name information included in the type information is “beer 3” is determined to be a drink not available for sale. The drinks corresponding to the seven pieces of product information excluding these two pieces of product information are determined to be drinks available for sale.

As illustrated in FIG. 20, the computation unit 104 refers to each piece of product information (FIG. 16) acquired prior to the drink determination process, and stores the product name (for example, coffee 1) indicated by the product name information included in the product information in a field “product name” of the work table 2500 illustrated in FIG. 20. The computation unit 104 then stores a result of the determination obtained in step S401 in a field “available for sale” of the work table 2500.

“OK” in the field “available for sale” in FIG. 20 indicates that the drink with the product name (for example, coffee 2) indicated by the field “product name” corresponding to the field “available for sale” is determined to be a drink available for sale. “NG (sold out)” in the field “available for sale” in FIG. 20 indicates that the drink with the product name (for example, beer 2) indicated by the field “product name” corresponding to the field “available for sale” is determined to be sold out and thus is a drink not available for sale. “NG (unsuitable temperature)” in the field “available for sale” in FIG. 20 indicates that the drink with the product name (for example, beer 3) indicated by the field “product name” corresponding to the field “available for sale” is determined to have an unsuitable temperature and thus is a drink not available for sale.

Based on the biological information (FIG. 17) acquired before the drink determination processing, the computation unit 104 then determines whether the risk of heatstroke of the user is at a level at which notification by the push notification screen 800 is necessary (step S402).

Specifically, the determination table 2400 illustrated in FIG. 19 is stored in advance in the memory 102. A field “body temperature” is a field indicating a range (for example, higher than or equal to 36.7 and lower than 37) of the body temperature (° C.) for determining the risk of heatstroke. A field “body water percentage” is a field indicating a range (for example, higher than or equal to 57 and lower than 60) of the body water percentage (%) used for determining the risk of heatstroke.

A field “necessity of push notification” is a field indicating whether the risk of heatstroke of the user is at a level at which notification by the push notification screen 800 is necessary (for example, yes) or not (for example, no).

A field “priority” is a field indicating priorities (for example, 1 to 4, a smaller numerical value indicates a higher priority) when each kind of drink (for example, an oral rehydration solution, a sports drink, and water) is recommended as a drink suitable for hydration for prevention of heatstroke.

In step S402, the computation unit 104 acquires a record in which the most recent date and time (for example, 20200414090000) is stored in the field “measurement date and time” in the biological information (FIG. 17), as a record indicating the current physical condition of the user. The computation unit 104 then acquires the body water percentage (for example, 56.1) and the body temperature (for example, 36.8) stored in the fields “body water percentage” and “body temperature” of the acquired record, as the current body water percentage and the current body temperature of the user, respectively.

The computation unit 104 refers to the field “necessity of push notification” (for example, yes) of a record in which the range (for example, higher than or equal to 36.7 and lower than 37) including the acquired current body temperature (for example, 36.8) of the user is indicated in the “body temperature” field in the determination table 2400 stored in the memory 102. The computation unit 104 also refers to the field “necessity of push notification” (for example, yes) of a record in which the range (for example, higher than or equal to 55 and lower than 57) including the acquired current body water percentage (for example, 56.1) of the user is indicated in the field “body water percentage” in the determination table 2400 stored in the memory 102.

If at least one of the referred contents of the field “necessity of push notification” indicates that the risk of heatstroke of the user is at a level at which the notification by the push notification screen 800 is necessary (for example, yes), the computation unit 104 determines that the risk of heatstroke of the user is at a level at which the notification by the push notification screen 800 is necessary.

The configuration is not limited to this. The computation unit 104 may determine that the risk of heatstroke of the user is at a level at which the notification by the push notification screen 800 is necessary if all of the plurality of referred contents of the field “necessity of push notification” indicate that the risk of heatstroke of the user is at a level at which the notification by the push notification screen 800 is necessary (for example, yes).

In step S402, if the computation unit 104 determines that the risk of heatstroke of the user is not at a level at which the notification by the push notification screen 800 is necessary (NO in step S402), the drink determination process ends. In this case, in step S207 illustrated in FIG. 7B, the computation unit 104 determines that the notification by the push notification screen 800 is not necessary, and ends the process.

On the other hand, in step S402, if the computation unit 104 determines that the risk of heatstroke of the user is at a level at which the notification by the push notification screen 800 is necessary (YES in step S402), the computation unit 104 determines that the notification by the push notification screen 800 is necessary, and performs processing of step S403 and the subsequent step.

In step S403, based on the biological information (FIG. 17) acquired prior to the drink determination process, the computation unit 104 determines, for each kind of drink, a priority for recommending each kind of drink as a drink suitable for hydration for prevention of heatstroke in accordance with the risk of heatstroke of the user (step S403).

Specifically, in step S403, the computation unit 104 refers to the field “necessity of push notification” of a record in which a range (for example, higher than or equal to 36.7 and lower than 37) including the current body temperature (for example, 36.8) of the user acquired from the biological information (FIG. 17) is indicated in the field “body temperature” in the determination table 2400 stored in the memory 102, as in step S402. As in step S402, the computation unit 104 also refers to the field “necessity of push notification” of a record in which a range (for example, higher than or equal to 55 and lower than 57) including the current body water percentage (for example, 56.1) of the user acquired from the biological information (FIG. 17) is indicated in the field “body water percentage” in the determination table 2400 stored in the memory 102.

Suppose that only one content in the field “necessity of push notification” among the two contents of the field “necessity of push notification” referred to by the computation unit 104 indicates that the risk of heatstroke of the user is at a level at which the notification by the push notification screen 800 is necessary (for example, yes). In this case, the computation unit 104 determines the priorities of recommending various kinds of drinks as drinks suitable for hydration for prevention of heatstroke, based on the priorities indicated by the field “priority” of the record including the only one content of the field “necessity of push notification”.

For example, as a first specific example, the one content of the field “necessity of push notification” is the content of the field “necessity of push notification” of the first record from the top in the determination table 2400 illustrated in FIG. 19. In this case, the computation unit 104 determines that the priority of recommending a drink of which the kind is “oral rehydration solution” as the drink suitable for hydration for prevention of heatstroke is “1” based on the priority of the drink of which the kind is “oral rehydration solution” in the field “priority” of the record. Likewise, the computation unit 104 determines that the priorities of recommending drinks of which the kinds are “sports drinks”, “water”, and “others” as drinks suitable for hydration for prevention of heatstroke are “2”, “3”, and “4”, based on the priorities of the drinks of which the kinds are “sports drink”, “water”, and “others” in the field “priority” field in the record.

In the first specific example, since the current body temperature of the user is included in the range “higher than 37” indicated by the field “body temperature” of the first record or the current body water percentage of the user is included in the range “lower than 55” indicated by the field “body water percentage” of the record, it is considered that the risk of heatstroke of the user is severe. In this case, a drink of which the kind is “oral rehydration solution” is recommended as the drink most suitable for hydration for prevention of heatstroke, and a drink of which the kind is “sports drink” is recommended as the drink second most suitable for hydration for prevention of heatstroke. Then, the drink of which the kind is “water” is recommended as the drink third most suitable for hydration for prevention of heatstroke, and the drink of which the kind is “others” is recommended as the drink fourth most suitable for hydration for prevention of heatstroke.

For example, as a second specific example, the one content of the field “necessity of push notification” is the content of the field “necessity of push notification” of the second record from the top in the determination table 2400 illustrated in FIG. 19. In this case, priorities of recommending drinks of which the kinds are “oral rehydration solution”, “sports drink”, “water”, and “others” as the drinks suitable for hydration for prevention of heatstroke are determined to be 3, 1, 2, and 4, respectively.

In the second specific example, since the current body temperature of the user is included in the range “higher than or equal to 36.7 and lower than 37” indicated by the field “body temperature” of the second record or the current body water percentage of the user is included in the range “higher than or equal to 57 and lower than 60” indicated by the field “body water percentage” of the record, it is considered that the risk of heatstroke of the user is lower than that in the first specific example. In this case, drinks of which the kinds are “sports drink”, “water”, “oral rehydration solution”, and “others” are recommended in this order as drinks suitable for hydration for prevention of heatstroke.

For example, as a third specific example, the one content of the field “necessity of push notification” is the content of the field “necessity of push notification” of the third record from the top in the determination table 2400 illustrated in FIG. 19. In this case, priorities of recommending drinks of which the kinds are “oral rehydration solution”, “sports drink”, “water”, and “others” as the drinks suitable for hydration for prevention of heatstroke are determined to be 3, 2, 1, and 4, respectively.

In the third specific example, since the current body temperature of the user is included in the range “higher than or equal to 36.5 and lower than 36.7” indicated by the field “body temperature” of the third record or the current body water percentage of the user is included in the range “higher than or equal to 55 and lower than 57” indicated by the field “body water percentage” of the record, it is considered that the risk of heatstroke of the user is lower than that in the second specific example by one step. In this case, drinks of which the kinds are “water”, “sports drink”, “oral rehydration solution”, and “others” are recommended in this order as drinks suitable for hydration for prevention of heatstroke.

That is, when the risk of heatstroke of the user has decreased to a level of the third specific example, the computation unit 104 recommends the drink of which the kind is “water” as the first ranking, the drink of which the kind is “sports drink” as the second ranking, the drink of which the kind is “oral rehydration solution” as the third ranking, and the drink of which the kind is “others” as the fourth ranking by using the determination table 2400 illustrated in FIG. 19.

In other words, when the risk of heatstroke of the user is as low as the level of the third specific example, the computation unit 104 recommends a drink of which the kind is “water” as the drink most suitable for hydrating the user to prevent heatstroke. When the risk of heatstroke of the user is intermediate, the computation unit 104 recommends a drink of which the kind is “sports drink” as the drink most suitable for hydrating the user to prevent heatstroke. When the risk of heatstroke of the user is severe, the computation unit 104 recommends a drink of which the kind is “oral rehydration solution” as the drink most suitable for hydrating the user to prevent heatstroke.

Suppose that all of the plurality of contents of the field “necessity of push notification” referred to by the computation unit 104 indicate that the risk of heatstroke of the user is at a level at which the notification by the push notification screen 800 is necessary (for example, yes). In this case, when the plurality of contents of the field “necessity of push notification” are included in the same record, the computation unit 104 determines that the priorities of recommending drinks of the respective kinds as the drinks suitable for hydration for prevention of heatstroke are the priorities indicated by the field “priority” in the record.

On the other hand, when the plurality of contents of the field “necessity of push notification” are included in two records different from each other, the computation unit 104 determines that the priorities of recommending drinks of respective kinds as the drinks suitable for hydration for prevention of heatstroke are, for example, priorities indicated by the field “priority” of the record in which the field “body temperature” indicates a high body temperature range or the field “body water percentage” indicates a low body water percentage range among the plurality of records. That is, the kind of drink to be prioritized is determined in accordance with a more severe record in the determination table 2400. Thus, the computation unit 104 determines the priorities of recommending various kinds of drinks as drinks suitable for hydration for prevention of heatstroke, based on the priorities indicated by the field “priority” of the record indicating that the risk of heatstroke of the user is more severe.

However, the configuration is not limited to this. The computation unit 104 may determine the priorities of recommending drinks of various kinds as the drinks suitable for hydration for prevention of heatstroke to be, for example, priorities indicated by the field “priority” of the record in which the field “body temperature” indicates a low body temperature range or the field “body water percentage” indicates a high body water percentage range among the plurality of records. That is, the kind of drink to be prioritized is determined in accordance with a less severe record in the determination table 2400. Thus, the computation unit 104 may determine the priorities of recommending various kinds of drinks as drinks suitable for hydration for prevention of heatstroke, based on the priorities indicated by the field “priority” of the record indicating that the risk of heatstroke of the user is less severe.

After step S403, the computation unit 104 determines at least one drink to be recommended in the push notification screen 800, based on results of steps S401 and S403 (step S404), and ends the drink determination process.

Specifically, in step S404, the computation unit 104 assigns priorities corresponding to the kinds of the drinks determined in step S403 to the respective drinks determined to be available for sale in step S401.

Specifically, in the work table 2500 (FIG. 20), the computation unit 104 stores the priorities corresponding to the respective kinds of drinks having the product names indicated by the field “product name” of the record determined in step S403, in the field “priority for each product” of the record that corresponds to the drink available for sale and in which “OK” is stored in the field “available for sale” in step S401. The computation unit 104 refers to the product name information and the kind information included in each piece of product information (FIG. 16) acquired prior to the drink determination process to grasp the kinds of drinks having the product names indicated by the field “product name”.

For example, as a result of performing step S401, a product name indicated by the product name information included in each piece of product information illustrated in FIG. 16 and the determination result obtained in step S401 are stored in the fields “product name” and “available for sale” of each record of the work table 2500 as illustrated in FIG. 20.

In step S403, the computation unit 104 determines the priority of recommending each kind of drink as a drink suitable for hydration for prevention of heatstroke by using a record (first record) in which the field “body temperature” is “higher than or equal to 37” in the determination table 2400 illustrated in FIG. 19. That is, priorities of recommending drinks of which the kinds are “oral rehydration solution”, “sports drink”, “water”, and “others” as the drinks suitable for hydration for prevention of heatstroke are determined to be 1, 2, 3, and 4, respectively.

In this case, in step S404, the computation unit 104 stores the priority “1” corresponding to “oral rehydration solution” that is the kind of the drink available for sale and determined in step S403, in the field “priority for each product” of the record of the drink for which the field “available for sale” is “OK” and the field “product name” indicates “oral rehydration solution” as indicated in a third column (“higher than or equal to 37” and “lower than 55”) of the field “priority for each product” of the work table 2500 in FIG. 20.

Likewise, the computation unit 104 stores the priorities “3” and “2” corresponding to “water” and “sports drink” which are the kinds of drinks determined in step S403, in the field “priority for each product” of the records of the drinks available for sale in which the field “available for sale” is “OK” and the field “product name” indicates “water” and “sports drink”.

Likewise, the computation unit 104 stores the priority “4” corresponding to “others” which is the kind of drink determined in step S403, in the field “priority for each product” of the record of the drink available for sale in which the field “available for sale” is “OK” and the field “product name” indicates a product name other than “oral rehydration solution”, “water”, and “sports drink”.

The first column of the field “priority for each product” of the work table 2500 of FIG. 20 indicates the priority stored in step S404 when the computation unit 104 determines the priority of recommending each kind of drink as a drink suitable for hydration for prevention of heatstroke by using a record (third record) in which the field “body temperature” is “higher than or equal to 36.5 and lower than 36.7” in the determination table 2400 illustrated in FIG. 19 in step S403.

The second column of the field “priority for each product” of the work table 2500 of FIG. 20 indicates the priority stored in step S404 when the computation unit 104 determines the priority of recommending each kind of drink as a drink suitable for hydration for prevention of heatstroke by using a record (second record) in which the field “body temperature” is “higher than or equal to 36.7 and lower than 37” in the determination table 2400 illustrated in FIG. 19 in step S403.

Thus, the computation unit 104 determines a drink determined to be available for sale in step S401 and corresponding to the record in which the field “available for sale” indicates “OK” in the work table 2500 of FIG. 20, as the drink recommended as the drink suitable for hydration for prevention of heatstroke. The computation unit 104 determines the priority indicated by the field “priority for each product” of the record corresponding to each of the drinks determined to be available for sale in step S401, as the priority of recommending the drink as the drink suitable for hydration for prevention of heatstroke.

In the first embodiment, the computation unit 104 performs the drink determination process in step S207 (FIG. 7B). When the step S404 is performed, the computation unit 104 generates the push notification screen 800 using the work table 2500 obtained as a result of performing the drink determination process. In step S210 (FIG. 7B), the computation unit 104 generates the individual purchase menu 900 using the work table 2500.

Specifically, in step S207 (FIG. 7B), the computation unit 104 includes a message that recommends a drink corresponding to a record in which “1” is stored in the field “priority for each product” of the work table 2500 illustrated in FIG. 20 in the message 820 included in the push notification screens 800B and 800C illustrated in FIGS. 9 and 11, respectively. In step S403, the computation unit 104 includes one or more of the current body temperature and/or the current body water percentage of the user acquired from the biological information (FIG. 17) in the message 820.

In step S210 (FIG. 7B), the computation unit 104 generates the large tile object 903 (such as FIG. 12) indicating a drink corresponding to a record in which the priority “1” is stored in the field “priority for each product” of the work table 2500. In step S210 (FIG. 7B), the computation unit 104 generates the tile object 901 (such as FIG. 12) indicating a drink corresponding to a record in which the priority “2” or less is stored in the field “priority for each product” of the work table 2500.

As described above, the computation unit 104 then arranges the large tile object 903 and the tile objects 901 according to the priorities stored in the field “priority for each product” of the records corresponding to the respective drinks indicated by the large tile object 903 and the tile objects 901.

### Second Embodiment

A second embodiment of the present disclosure will be described below. In the first embodiment, an example has been described in which the business entity X application in the communication terminal 100 acquires the biological information of the user of the communication terminal 100 from the personal information server 200 and the communication terminal 100. The second embodiment is different from the first embodiment in that the business entity X application in the communication terminal 100 acquires the biological information of the user of the communication terminal 100 from the sensor application in the communication terminal 100.

In the second embodiment, the memory 102 of the communication terminal 100 has a table having the same configuration as the biological information table 2300 illustrated in FIG. 17. For convenience of explanation, the table is hereinafter referred to as the biological information table 2300. The sensor application collects the biological information of the user of the communication terminal 100 periodically measured by the biological sensor 600, and stores the collected biological information in the biological information table 2300 (FIG. 17) in time series in association with the user ID of the user and the measurement date and time information indicating the measurement date and time of the biological information.

An overview of a process performed in the vending machine management system in the second embodiment will be described below. In the description below, a description of processing having the same details as those of the first embodiment is omitted as appropriate. FIGS. 21A and 21B are a sequence diagram illustrating an example of the overview of the process performed in the vending machine management system in the second embodiment.

As illustrated in FIGS. 21A, in the second embodiment, step S204a is performed instead of step S204 (FIG. 7A) in the first embodiment.

In step S204a, the computation unit 104 executes the sensor application to acquire records including the user ID of the user of the communication terminal 100 in the biological information table 2300 (FIG. 17) in the memory 102, as the biological information of the user (step S204a). Thereafter, the processing of step S207 and subsequent steps is performed as in the first embodiment.

In the second embodiment, in step S207, the computation unit 104 performs the drink determination process (steps S401 to S404 (FIG. 18)) as in the first embodiment by using each combination of the identification information of the vending machines 700 and the type information and the stock information included in the product information which are acquired in step S202 each time a beacon signal is received and the biological information of the user of the communication terminal 100 acquired in step S204a. When the step S404 (FIG. 18) is performed, the computation unit 104 generates the push notification screen 800 using the work table 2500 (FIG. 20) obtained as a result of performing the drink determination process. In step S210 (FIG. 7B), the computation unit 104 generates the individual purchase menu 900 by using the work table 2500 (FIG. 20).

### Third Embodiment

A third embodiment of the present disclosure will be described below. In the first embodiment, an example has been described in which the business entity X application in the communication terminal 100 acquires the biological information of the user of the communication terminal 100 from the personal information server 200 and the communication terminal 100, generates the push notification screen 800 and the individual purchase menu 900, and notifies the personal information server 200 of the purchase information of the drink by the user of the communication terminal 100.

The third embodiment is different from the first embodiment in that the business entity management server 300 used by the business entity X that provides the business entity X application acquires the biological information of the user of the communication terminal 100 from the personal information server 200, generates the push notification screen 800 and the individual purchase menu 900, and notifies the personal information server 200 of the purchase information of the drink by the user of the communication terminal 100.

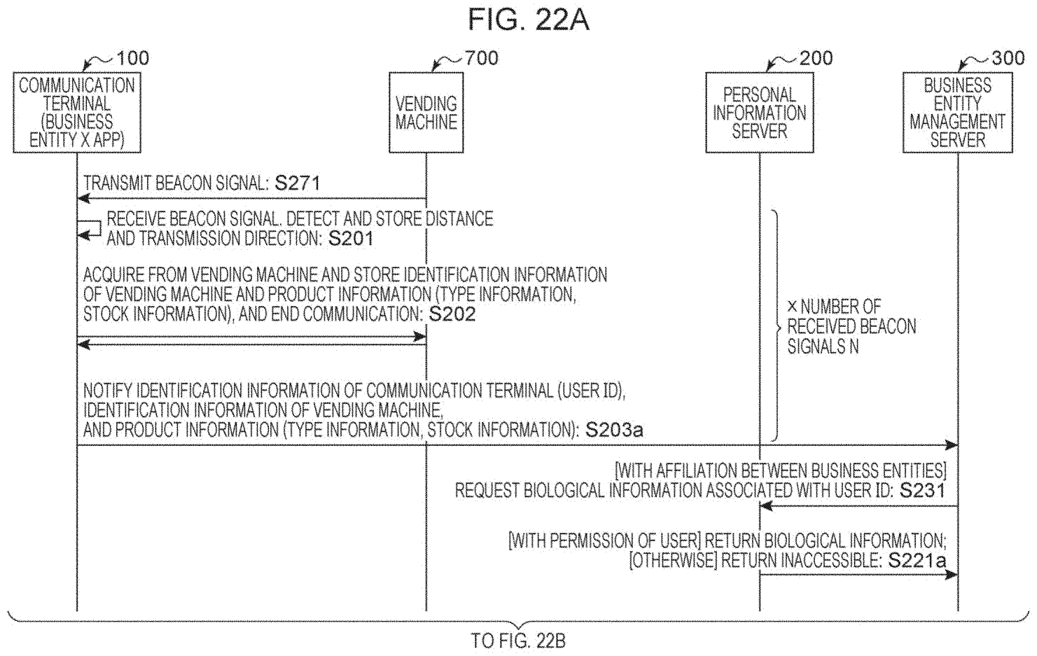

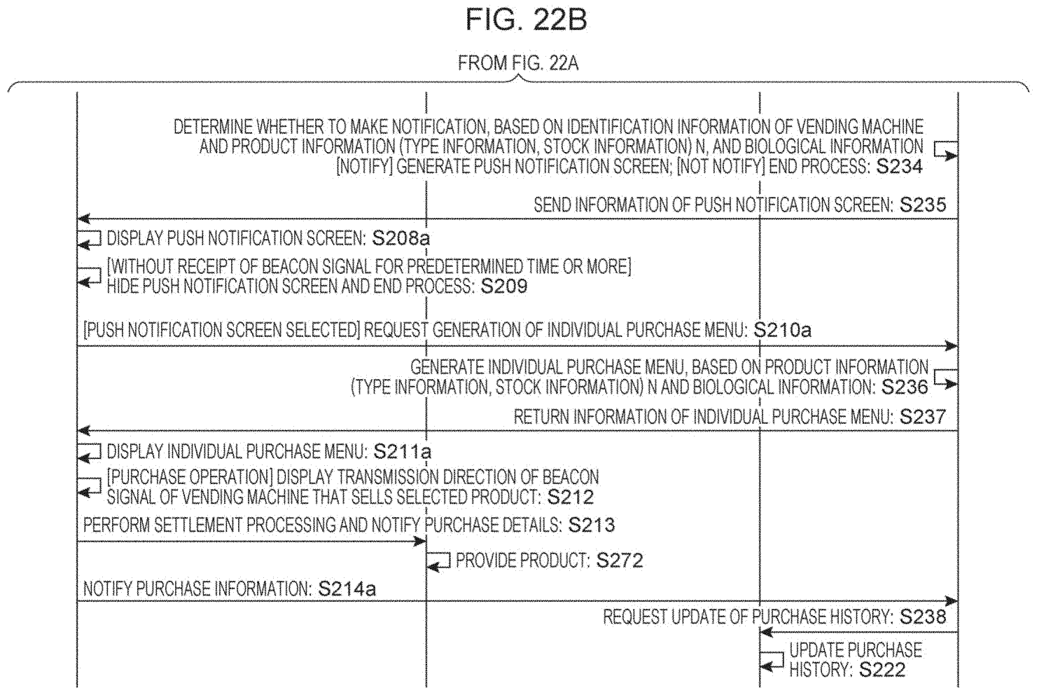

An overview of a process performed in the vending machine management system in the third embodiment will be described below. In the description below, a description of processing having the same details as those of the first embodiment is omitted as appropriate. FIGS. 22A and 22B are a sequence diagram illustrating an example of the overview of the process performed in the vending machine management system in the third embodiment.

As illustrated in FIG. 22A, the proximity communication unit 707 of each of the vending machines 700 included in the vending machine management system periodically transmits a beacon signal (step S271) as in the first embodiment.

The business entity X application is executed in the communication terminal 100, so that step S201 is performed as in the first embodiment. Thus, information indicating the distance to the vending machine 700 that is the transmission source of the beacon signal and the transmission direction of the beacon signal as well as the beacon ID are stored in the memory 102. Step S202 is performed, so that the identification information for identifying the vending machine 700 and the product information including the type information and the stock information are stored in the memory 102.

The computation unit 104 then controls the communication unit 101 to send, to the business entity management server 300, pieces of information stored in the memory 102, i.e., the identification information for identifying the communication terminal 100 including the user ID, and the identification information and product information of each of the vending machines 700 which are the transmission sources of the respective beacon signals acquired in step S202 (step S203a).

In response to this, in the business entity management server 300, based on the identification information of the vending machine 700 and the product information acquired via the communication unit 301, the computation unit 302 updates the product information of the vending machine 700 corresponding to the identification information and stored in the memory 303.

In this way, each time the proximity communication unit 107 of the communication terminal 100 receives a beacon signal transmitted from the proximity communication unit 707 of the vending machine 700, the processing from step S201 to step S203a is repeated in response to the receipt.

In response to detecting that a plurality of beacon signals transmitted from the plurality of vending machines 700 are received by the proximity communication unit 107, the computation unit 104 may perform merely steps S201 and S202 at receipt of each of the beacon signals by the proximity communication unit 107 and may perform step S203a just once (or the number of times less than the number of iterations of step S202). Thus, the computation unit 104 may collectively send the identification information for identifying the communication terminal 100 including the user ID, the identification information of each of the vending machines 700 and the product information that are acquired in steps S201 and S202 to the business entity management server 300 in single step S203a.

Suppose that the business entity X that provides the business entity X application has an affiliation with the managing business entity of the personal information server 200 and that the business entity X or the business entity X application is permitted to acquire personal information of each user stored in the personal information server 200. In this case ([with affiliation between business entities]), the computation unit 302 of the business entity management server 300 controls the communication unit 301 to send, to the personal information server 200, a signal requesting sending of biological information of the user identified by the user ID included in the identification information, together with identification information for identifying the communication terminal 100 acquired from the communication terminal 100 (step S231).

In the personal information server 200, in response to the communication unit 201 receiving the identification information (including the user ID for identifying the user) for identifying the communication terminal 100 and the signal requesting sending of the biological information of the user, which are sent in step S231, the computation unit 202 performs processing of step S221a (step S221a).

Specifically, in step S221a, if the computation unit 202 determines that the user indicated by the user ID included in the identification information received by the communication unit 201 is a user with permission ([with permission of user]), the computation unit 202 controls the communication unit 201 to return the biological information of the user with permission acquired from the memory 203 to the business entity management server 300. On the other hand, if the computation unit 202 determines that the user is not a user with permission ([otherwise]), the computation unit 202 controls the communication unit 201 to return information indicating that the personal information is inaccessible to the business entity management server 300. The returned information is received and output to the computation unit 302 by the communication unit 301 of the business entity management server 300.

If the computation unit 202 determines that the user is not a user with permission ([otherwise]), the computation unit 202 may control the communication unit 201 to send a message for checking whether to permit the business entity management server 300 to read the personal information, to the communication terminal 100 indicated by the identification information acquired from the business entity management server 300. Suppose that in response to this, the computation unit 202 acquires a reply indicating permission from the communication terminal 100 via the communication unit 201. In this case, the computation unit 202 may acquire, from the memory 203, the biological information of the user indicated by the user ID included in the received identification information in step S221a. The computation unit 202 then may cause the communication unit 201 to return the acquired information to the business entity management server 300.

The computation unit 302 then performs step S234 (step S234). In step S234, the computation unit 302 first determines whether to make notification by the push notification screen 800, based on each combination of the identification information of the vending machines 700 and the type information and the stock information included in the product information and the biological information of the user of the communication terminal 100, which are acquired in the preceding steps. Each combination of the identification information of the vending machines 700 and the type information and the stock information included in the product information is a combination sent and acquired via the communication unit 301 in step S203a. The biological information is the biological information returned and acquired via the communication unit 301 in step S221a.

In the third embodiment, in step S234, the computation unit 302 performs the drink determination process (steps S401 to S404 (FIG. 18)) by using each combination of the identification information of the vending machine 700 and the type information and the stock information included in the product information and the biological information of the user of the communication terminal 100.

As a result of performing step S402 (FIG. 18), if the computation unit 302 determines not to make notification by the push notification screen ([not notify]), the computation unit 104 ends the process. If there is no reply from the business entity management server 300 before a predetermined time elapses since the execution of step S203a, the computation unit 104 of the communication terminal 100 ends the process and returns to a state of waiting for receipt of a beacon signal by the proximity communication unit 107, similarly to immediately after the start of the execution of the business entity X application.

As a result of performing step S402 (FIG. 18), if the computation unit 302 determines to make notification by the push notification screen ([notify]), the computation unit 302 continues the drink determination process and generates the push notification screen 800 by using the work table 2500 (FIG. 20) obtained as a result of the drink determination process.

Next, the computation unit 302 controls the communication unit 301 to send information representing the push notification screen 800 generated in step S234 to the communication terminal 100 (step S235).

On the other hand, in the communication terminal 100, in response to acquiring, via the communication unit 101, the information representing the push notification screen 800 sent in step S235, the computation unit 104 displays the push notification screen 800 represented by the acquired information on the display 105 of the communication terminal 100 (step S208a).

If receipt of a beacon signal by the proximity communication unit 107 is not detected for a predetermined time or more since the push notification screen 800 is displayed in step S208a, ([without receipt of beacon signal for predetermined time or more]), the computation unit 104 performs processing of hiding the displayed push notification screen 800 to hide the push notification screen 800. The computation unit 104 then ends the process (step S209). After ending the process, the computation unit 104 returns to a state of waiting for receipt of a beacon signal by the proximity communication unit 107.

On the other hand, if the user performs an operation (for example, a touch operation) of selecting the push notification screen 800 by using the operation unit 106 ([push notification screen selected]), the computation unit 104 controls the communication unit 101 to send a signal requesting generation of the individual purchase menu 900 to the business entity management server 300 (step S210a). The signal requesting generation of the individual purchase menu 900 is received and output to the computation unit 302 by the communication unit 301 of the business entity management server 300.

In response to acquiring, via the communication unit 301, the signal requesting generation of the individual purchase menu 900 sent in step S210a, the computation unit 302 generates the individual purchase menu 900, based on the type information and the stock information included in the product information and the biological information of the user of the communication terminal 100 that are used in step S234 (step S236).

In step S236, the computation unit 302 generates the individual purchase menu 900 by using the work table 2500 (FIG. 20) obtained by performing the drink determination process (steps S401 to S404 (FIG. 18)) in step S234.

Next, the computation unit 302 controls the communication unit 301 to send information representing the individual purchase menu 900 generated in step S236, to the communication terminal 100 (step S237).

In the communication terminal 100, in response to acquiring, via the communication unit 101, the information representing the individual purchase menu 900 sent in step S237, the computation unit 104 displays the individual purchase menu 900 represented by the acquired information on the display 105 of the communication terminal 100 (step S211a).

After step S211a, as in the first embodiment, steps S212, S213, and S272 are performed, so that the drink purchased by the user is provided to the user.

After step S213, the computation unit 104 of the communication terminal 100 controls the communication unit 101 to send the purchase information of the drink to the business entity management server 300 (step S214a). Thus, in the business entity management server 300, the purchase information of the drink sent in step S214a is received and output to the computation unit 302 by the communication unit 301. The purchase information of the drink includes the user ID of the user of the communication terminal 100, the date and time information indicating the purchase date and time of the drink by the user, the identification information for identifying the vending machine 700 from which the user purchased the drink, and the type information indicating the type of the drink purchased by the user (or merely the product name information indicating the product name).

In response to acquiring the purchase information of the drink from the communication unit 301, the computation unit 302 of the business entity management server 300 causes the communication unit 301 to send a signal requesting update of the purchase history information of the user of the communication terminal 100 to the personal information server 200 together with the acquired purchase information of the drink (step S238). In response to this, step S222 is performed in the personal information server 200 as in the first embodiment, and if the user of the communication terminal 100 is a user with permission, the purchase history information of the user with permission stored in the memory 203 is updated.

### Fourth Embodiment

A fourth embodiment of the present disclosure will be described below. In the third embodiment, an example has been described in which the business entity management server 300 acquires the biological information of the user of the communication terminal 100 from the personal information server 200. The fourth embodiment is different from the third embodiment in that the business entity management server 300 requests the sensor application in the communication terminal 100 to send the biological information of the user of the communication terminal 100 and acquires the biological information from the sensor application.

In the fourth embodiment, the memory 102 of the communication terminal 100 has a table having the same configuration as the biological information table 2300 illustrated in FIG. 17 as in the second embodiment. For convenience of explanation, the table is hereinafter referred to as the biological information table 2300. As in the second embodiment, the sensor application collects the biological information of the user of the communication terminal 100 periodically measured by the biological sensor 600, and stores the collected biological information in the biological information table 2300 (FIG. 17) in time series in association with the user ID of the user and the measurement date and time information indicating the measurement date and time of the biological information.

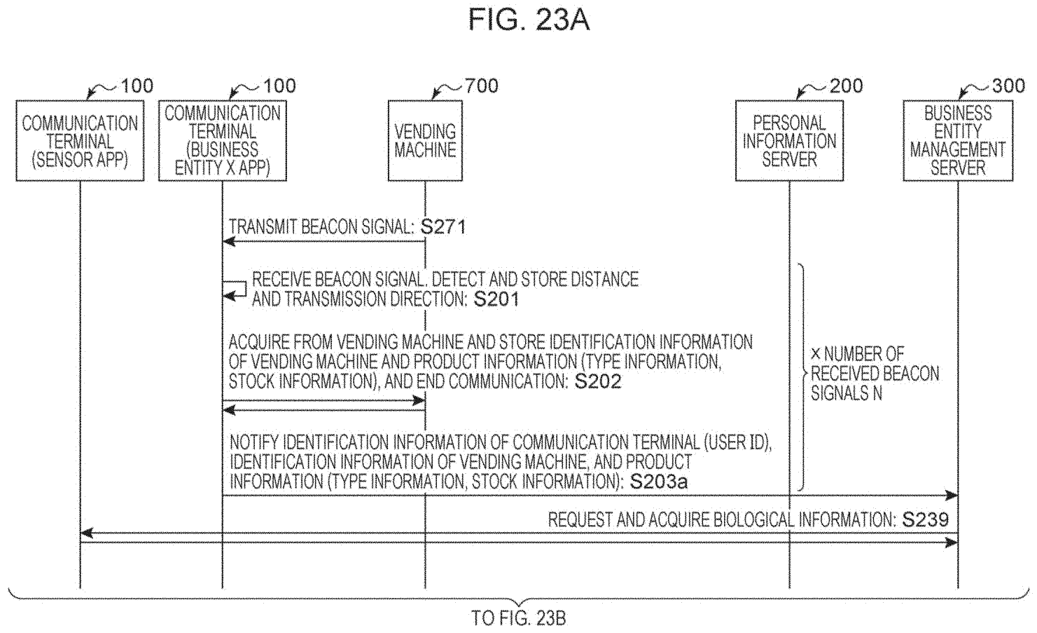

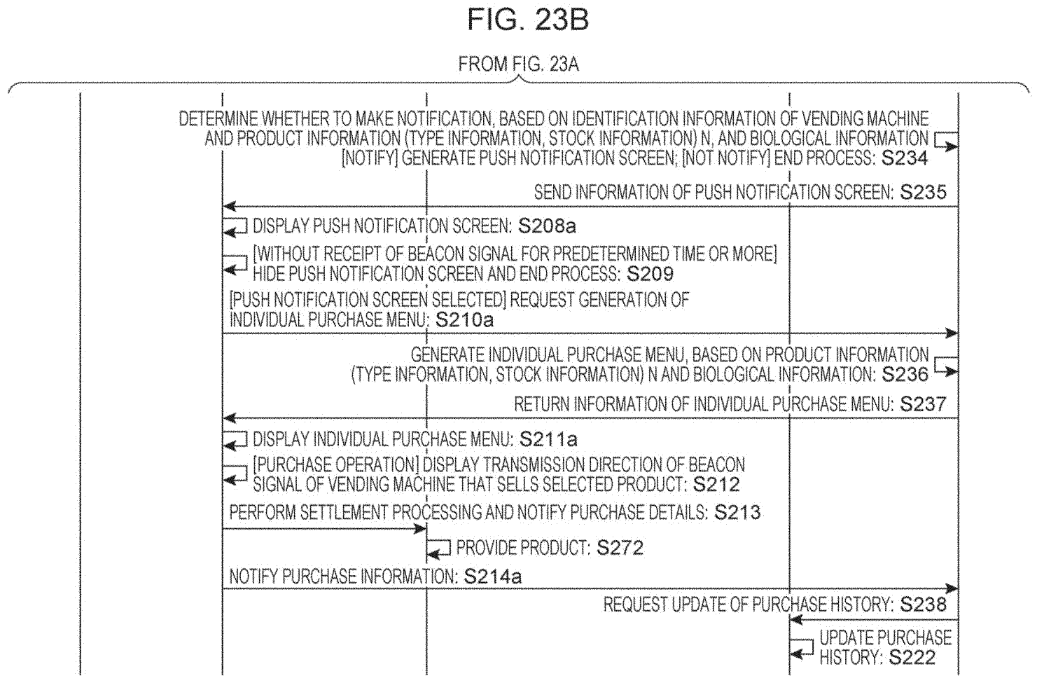

An overview of a process performed in the vending machine management system in the fourth embodiment will be described below. In the description below, a description of processing having the same details as those of the third embodiment is omitted as appropriate. FIGS. 23A and 23B are a sequence diagram illustrating an example of the overview of the process performed in the vending machine management system in the fourth embodiment.

As illustrated in FIGS. 23A, in the fourth embodiment, step S239 is performed instead of step S231 (FIG. 22A) in the third embodiment (step S239).

In step S239, the computation unit 302 requests the communication terminal 100 indicated by the terminal ID included in the identification information for identifying the communication terminal 100 acquired in step S203a to provide the biological information of the user of the communication terminal 100, and acquires the biological information of the user of the communication terminal 100 returned in response the request (step S239).

Specifically, in step S239, the computation unit 302 controls the communication unit 301 to send a signal requesting the biological information of the user of the communication terminal 100 to the communication terminal 100 indicated by the terminal ID included in the identification information for identifying the communication terminal 100 acquired in step S203a. In the communication terminal 100, in response to the communication unit 101 receiving the signal requesting the biological information of the user of the communication terminal 100, the communication unit 101 notifies the computation unit 104 of the receipt. In response to receiving the notification, the computation unit 104 executes the sensor application to acquire records including the user ID of the user of the communication terminal 100 in the biological information table 2300 (FIG. 17) in the memory 102, as the biological information of the user. The computation unit 104 then causes the communication unit 101 to return the acquired biological information. In response to this, the computation unit 302 of the business entity management server 300 acquires, via the communication unit 301, the biological information of the user of the communication terminal 100 returned from the communication terminal 100. Thereafter, the processing of step S234 and subsequent steps is performed as in the third embodiment.

“The sensor application is executed” herein. However, the present disclosure is not limited to this configuration. For example, the sensor application may authorize the business entity X application or an operating system (OS) of the communication terminal 100 to access the biological information stored in the memory 102. In this case, the biological information requested by the business entity management server 300 may be acquired from one or more records including the user ID of the user of the communication terminal 100 in the biological information table 2300 in the memory 102 via the business entity X application or the OS. From among the one or more records, only one record in which the most recent date and time is stored in the field “measurement date and time” may be used.

In the fourth embodiment, in step S234, the computation unit 302 performs the drink determination process (steps S401 to S404 (FIG. 18)) by using each combination of the identification information of the vending machine 700 and the type information and the stock information included in the product information, which are sent and acquired via the communication unit 301 in step S203a, and the biological information acquired in step S239. When the step S404 (FIG. 18) is performed, the computation unit 302 generates the push notification screen 800 using the work table 2500 (FIG. 20) obtained as a result of performing the drink determination process. In step S236, the computation unit 302 generates the individual purchase menu 900 using the work table 2500 (FIG. 20).

### Modified Embodiments

In the embodiments described above, an example has been described in which in the drink determination process (steps S401 to S404 (FIG. 18)), the necessity of notification by the push notification screen 800 is determined in accordance with the risk of heatstroke of the user indicated by the current body temperature and/or current body water percentage of the user and a priority of recommending each kind of drink as a drink suitable for hydration for prevention of heatstroke is determined.

However, instead of this, in the drink determination process, the necessity of notification by the push notification screen 800 may be determined in accordance with the risk of heatstroke of the user indicated by an increasing degree of the body temperature of the user and/or a decreasing degree of the body water percentage of the user and a priority of recommending each kind of drink as a drink suitable for hydration for prevention of heatstroke may be determined.

Specifically, the determination table 2400 (FIG. 19) may be configured such that the fields “body temperature” and “body water percentage” indicate a range of the increasing degree of the body temperature of the user (for example, greater than or equal to +1 and less than +3(° C.)) and a range of the decreasing degree of the body water percentage of the user (for example, greater than or equal to −3 and less than −1(%)), respectively. In step S402 (FIG. 18) and step S403 (FIG. 18), the computation unit 104 may perform the processing in the following manner.

In step S402 (FIG. 18), the computation unit 104 acquires, from the biological information (FIG. 17) acquired prior to the drink determination process, a record (hereinafter, referred to as a current record) in which the most recent date and time is stored in the field “measurement date and time”, and a record (hereinafter, referred to as a past record) in which the date and time the next closest to the present is stored in the field “measurement date and time”.

The computation unit 104 calculates, as the increasing degree of the body temperature of the user, a result of subtracting the body temperature of the user indicated by the field “body temperature” field of the past record from the body temperature of the user indicated by the field “body temperature” field of the current record. Likewise, the computation unit 104 calculates, as the decreasing degree of the body water percentage of the user, a result of subtracting the body water percentage of the user indicated by the field “body water percentage” of the past record from the body water percentage of the user indicated by the field “body water percentage” of the current record.

The computation unit 104 refers to the field “necessity of push notification” of a record in which the range including the calculated increasing degree of the body temperature of the user is indicated in the field “body temperature” in the modified determination table 2400 and to the field “necessity of push notification” of a record in which the range including the calculated decreasing degree of the body water percentage of the user is indicated in the field “body water percentage” in the modified determination table 2400. As in the drink determination process in the first to fourth embodiments, the computation unit 104 then determines that the risk of heatstroke of the user is at a level at which notification by the push notification screen 800 is necessary in accordance with the contents indicated by the two fields “necessity of push notification” referred to above.

In step S403, as in the drink determination process in the embodiments described above, the computation unit 104 determines the priorities indicated by the field “priority” of a record including the field “necessity of push notification” indicating that the risk of heatstroke of the user is at a level at which notification by the push notification screen 800 is necessary (for example, yes) among the two fields “necessity of push notification” referred to, as the priorities of recommending respective kinds of drinks as drinks suitable for hydration for prevention of heatstroke.

For example, as in the drink determination process in the embodiments described above, the modified determination table 2400 is defined in the following manner. Specifically, in the field “body temperature” and the field “body water percentage” of the first record of the determination table 2400, the range of the increasing degree of the body temperature and the range of the decreasing degree of the body water percentage in a case where the risk of heatstroke of the user is considered to be severe are stored. Then, in the field “necessity of push notification” of the first record, information (for example, yes) indicating the risk of heatstroke of the user is at a level at which notification by the push notification screen 800 is necessary is stored. In the field “priority” of the first record, the priorities of drinks of which the kinds are “oral rehydration solution”, “sports drink”, “water”, and “others” are set to “1”, “2”, “3”, and “4”, respectively, as in the first specific example.

Likewise, in the field “body temperature” and the field “body water percentage” of the second record, the range of the increasing degree of the body temperature and the range of the decreasing degree of the body water percentage in a case where the risk of heatstroke of the user is considered to be intermediate are stored. Then, in the field “necessity of push notification” of the second record, information (for example, yes) indicating the risk of heatstroke of the user is at a level at which notification by the push notification screen 800 is necessary is stored. In the field “priority” of the second record, the priorities of drinks of which the kinds are “oral rehydration solution”, “sports drink”, “water”, and “others” are set to “3”, “1”, “2”, and “4”, respectively, as in the second specific example.

Likewise, in the field “body temperature” and the field “body water percentage” of the third record, the range of the increasing degree of the body temperature and the range of the decreasing degree of the body water percentage in a case where the risk of heatstroke of the user is low are stored. Then, in the field “necessity of push notification” of the third record, information (for example, yes) indicating the risk of heatstroke of the user is at a level at which notification by the push notification screen 800 is necessary is stored. In the field “priority” of the third record, the priorities of drinks of which the kinds are “oral rehydration solution”, “sports drink”, “water”, and “others” are set to “3”, “2”, “1”, and “4”, respectively, as in the third specific example.

In this case, in step S402, if the increasing degree of the body temperature of the user acquired from the biological information is included in the range indicated by the field “body temperature” of any of the first to third records, the computation unit 104 determines that the risk of heatstroke of the user is at a level at which notification by the push notification screen 800 is necessary using the determination table 2400. In step S402, if the decreasing degree of the body water percentage of the user acquired from the biological information is included in the range indicated by the field “body water percentage” of any of the first to third records, the computation unit 104 determines that the risk of heatstroke of the user is at a level at which notification by the push notification screen 800 is necessary using the determination table 2400.

That is, when the body temperature of the user increases by a predetermined amount and/or the body water percentage of the user decreases by a predetermined amount, the increasing degree of the body temperature of the user acquired from the biological information and/or the decreasing degree of the body water percentage of the user acquired from the biological information are included in the range indicated in the field “body temperature” or the field “body water percentage” of any of the first to third records corresponding to the case where the risk of heatstroke is mild or higher in the determination table 2400. In this case, the computation unit 104 determines that the risk of heatstroke of the user is at a level at which the notification by the push notification screen 800 is necessary. In this case, the computation unit 104 causes the push notification screen 800 to be displayed in step S208 (FIGS. 7B and 21B) or step S208a (FIGS. 22A and 23A).

In step S403, when the body temperature of the user acquired from the biological information increases by a predetermined amount and the increasing degree of the body temperature is included in the range indicated by the field “body temperature” of the third record corresponding to the case where the risk of heatstroke is low, the computation unit 104 recommends a drink of which the kind is “water” as the drink most suitable for hydrating the user to prevent heatstroke using the determination table 2400. In step S403, when the body water percentage of the user acquired from the biological information decreases by a predetermined amount and the decreasing degree of the body water percentage is included in the range indicated by the field “body water percentage” of the third record corresponding to the case where the risk of heatstroke is low, the computation unit 104 recommends a drink of which the kind is “water” as the drink most suitable for hydrating the user to prevent heatstroke using the determination table 2400.

In step S403, when the body temperature of the user acquired from the biological information increases by a predetermined amount and the increasing degree of the body temperature is included in the range indicated by the field “body temperature” of the second record corresponding to the case where the risk of heatstroke is intermediate, the computation unit 104 recommends a drink of which the kind is “sports drink” as the drink most suitable for hydrating the user to prevent heatstroke using the determination table 2400. In step S403, when the body water percentage of the user acquired from the biological information decreases by a predetermined amount and the decreasing degree of the body water percentage is included in the range indicated by the field “body water percentage” of the second record corresponding to the case where the risk of heatstroke is intermediate, the computation unit 104 recommends a drink of which the kind is “sports drink” as the drink most suitable for hydrating the user to prevent heatstroke using the determination table 2400.

In step S403, when the body temperature of the user acquired from the biological information increases by a predetermined amount and the increasing degree of the body temperature is included in the range indicated by the field “body temperature” of the first record corresponding to the case where the risk of heatstroke is severe, the computation unit 104 recommends a drink of which the kind is “oral rehydration solution” as the drink most suitable for hydrating the user to prevent heatstroke using the determination table 2400. In step S403, when the body water percentage of the user acquired from the biological information decreases by a predetermined amount and the decreasing degree of the body water percentage is included in the range indicated by the field “body water percentage” of the first record corresponding to the case where the risk of heatstroke is severe, the computation unit 104 recommends a drink of which the kind is “oral rehydration solution” as the drink most suitable for hydrating the user to prevent heatstroke using the determination table 2400.

That is, as the body temperature of the user increases, the computation unit 104 recommends a drink of which the kind is “water” when the increase is small, a drink of which the kind is “sports drink” when the increase is intermediate, and a drink of which the kind is “oral rehydration solution” when the increase is large, as the drink most suitable for hydrating the user using the determination table 2400. As the body water percentage of the user decreases, the computation unit 104 recommends a drink of which the kind is “water” when the decrease is small, a drink of which the kind is “sports drink” when the decrease is intermediate, and a drink of which the kind is “oral rehydration solution” when the decrease is large, as the drink most suitable for hydrating the user using the determination table 2400.

That is, when the increasing degree of the body temperature of the user is a degree in a case where the risk of heatstroke of the user is low, the computation unit 104 recommends a drink of which the kind is “water”, as the drink most suitable for hydrating the user to prevent heatstroke. When the increasing degree of the body temperature of the user is a degree in a case where the risk of heatstroke of the user is intermediate, the computation unit 104 recommends a drink of which the kind is “sports drink”, as the drink most suitable for hydrating the user to prevent heatstroke. When the increasing degree of the body temperature of the user is a degree in a case where the risk of heatstroke of the user is severe, the computation unit 104 recommends a drink of which the kind is “oral rehydration solution”, as the drink most suitable for hydrating the user to prevent heatstroke.

That is, when the decreasing degree of the body water percentage of the user is a degree in a case where the risk of heatstroke of the user is low, the computation unit 104 recommends a drink of which the kind is “water”, as the drink most suitable for hydrating the user to prevent heatstroke. When the decreasing degree of the body water percentage of the user is a degree in a case where the risk of heatstroke of the user is intermediate, the computation unit 104 recommends a drink of which the kind is “sports drink”, as the drink most suitable for hydrating the user to prevent heatstroke. When the decreasing degree of the body water percentage of the user is a degree in a case where the risk of heatstroke of the user is severe, the computation unit 104 recommends a drink of which the kind is “oral rehydration solution”, as the drink most suitable for hydrating the user to prevent heatstroke.

Similarly to the fields “body temperature” and “body water percentage”, the determination table 2400 may further include a field indicating any one of a heart rate, a blood pressure, or an amount of perspiration of the user included in the biological information. In the same manner as described above, in the drink determination processing, it may be determined whether notification by the push notification screen 800 is necessary in accordance with the risk of heatstroke of the user indicated by the any one of the above items acquired from the biological information, and a priority of recommending each kind of drink as a drink suitable for hydration for prevention of heatstroke may be determined.

In the above description, the “increasing degree of the body temperature” may be an amount of increase in body temperature of the user in a most recent predetermined time (for example, an amount of increase in body temperature in the most recent one hour), or may be an amount of increase in body temperature from a normal body temperature of the user (which may be any of an average body temperature, an average body temperature in a calm state, a body temperature at a predetermined time, or a body temperature at the time of wake-up).

The “decreasing degree of the body water percentage” may be an amount of decrease in body water percentage of the user in a most recent predetermined time (for example, an amount of decrease in body water percentage in the most recent one hour), or may be an amount of decrease in body water percentage from a normal body water percentage of the user (which may be any of an average body water percentage, an average body water percentage in a calm state, a body water percentage at a predetermined time, and a body water percentage at the time of wake-up).

In the above description, the priorities have been described that are given to the kinds of drinks suitable for hydrating the user to prevent heatstroke in accordance with the biological information of the user on the basis of the determination table 2400 or the modified example thereof. However, the present disclosure is not limited this configuration, and other sorting methods or other priority assignment may be used.

For example, the description has been given of definition of four cases for the biological information of the user based on the magnitude of the risk of heatstroke. However, the cases may be defined by finer steps (for example, eight cases) or coarser steps (for example, two cases). When the body temperature is higher than or equal to 37 degrees Celsius (° C.), the priorities are given in the order of “oral rehydration solution”, “sports drink”, “water”, and “others” in the determination table 2400 of FIG. 19. However, priorities may be given differently. In the determination table 2400 of FIG. 19, the description has been given separately for the body temperature and the body water percentage. However, the cases may be defined by a combination condition (for example, a combination condition of the body temperature, the blood pressure, and the heart rate) of two or more items of the biological information such as the body temperature, the body water percentage, the blood pressure, the heart rate, and the amount of perspiration.

The present disclosure is useful to determine a physical condition of a user at a timing when the user passes in front of a vending machine and recommend a drink suitable for hydrating the user to prevent heatstroke.

What is claimed is:

1. A method executed in a communication terminal, the communication terminal including a user ID for identifying a user of the communication terminal,
the method comprising causing a computer of the communication terminal to perform a process comprising:
acquiring, in response to receipt of a beacon signal from a vending machine of drinks, from the vending machine by using short-range wireless communication, i) identification information for identifying the vending machine, ii) type information indicating product names of a plurality of drinks stored in the vending machine, and iii) stock information indicating quantities of stock of the plurality of drinks stored in the vending machine;
transmitting the user ID to a personal information server that securely manages personal information including biological information that includes a body temperature or a body water percentage of the user of the communication terminal;
acquiring from the personal information server, the biological information of the user corresponding to the user ID, when it is confirmed at the personal information server the acquisition of the biological information of the user is permitted by the user;
generating a push notification screen, based on the identification information, the type information, the stock information, and the biological information, wherein the push notification screen recommends at least one drink suitable for hydrating the user to prevent heatstroke, from among the plurality of drinks stored in the vending machine indicated by the identification information; and
displaying the push notification screen on a display of the communication terminal.

2. The method according to claim 1, wherein
the push notification screen is used for displaying, on the display of the communication terminal, a purchase menu that allows the at least one drink to be purchased from among the plurality of drinks stored in the vending machine.

3. The method according to claim 1, wherein the process further comprises:
generating, when the push notification screen displayed on the display of the communication terminal is selected, an individual purchase menu for preventing heatstroke, based on the type information, the stock information, and the biological information, wherein the individual purchase menu displays the at least one drink suitable for hydrating the user to prevent heatstroke, from among the plurality of drinks stored in the vending machine indicated by the identification information; and
displaying the individual purchase menu on the display of the communication terminal.

4. The method according to claim 1, wherein the process further comprises:
displaying, on the display on which the push notification screen is displayed, a direction indicating a transmission direction of the beacon signal transmitted from the vending machine.

5. The method according to claim 3, wherein the process further comprises:
displaying, on the display on which the individual purchase menu is displayed, a direction indicating a transmission direction of the beacon signal transmitted from the vending machine.

6. The method according to claim 1, wherein the process further comprises:
receiving a beacon signal from the vending machine; and
erasing the displayed push notification screen after receipt of the beacon signal is not detected for a predetermined time.

7. The method according to claim 1, wherein
the at least one drink includes any one of water, a sports drink, or an oral rehydration solution.

8. The method according to claim 1, wherein
the push notification screen recommends, as the at least one drink, a sports drink rather than water as a risk of heatstroke of the user increases.

9. The method according to claim 8, wherein
the push notification screen recommends an oral rehydration solution rather than the sports drink as the risk of heatstroke of the user further increases.

10. The method according to claim 1, wherein
the biological information comprises information on a body temperature of the user, and
the push notification screen is displayed in response to an increase in the body temperature of the user by a predetermined amount.

11. The method according to claim 1, wherein
the biological information comprises information on a body temperature of the user, and
the push notification screen recommends, as the at least one drink, a sports drink rather than water as the body temperature of the user increases.

12. The method according to claim 11, wherein
the push notification screen recommends an oral rehydration solution rather than the sports drink as a risk of heatstroke of the user further increases.

13. The method according to claim 1, wherein
the biological information comprises information on a body water percentage of the user, and
the push notification screen is displayed in response to a decrease in the body water percentage of the user by a predetermined amount.

14. The method according to claim 1, wherein
the biological information comprises information on a body water percentage of the user, and
the push notification screen recommends, as the at least one drink, a sports drink rather than water as the body water percentage of the user decreases.

15. The method according to claim 14, wherein
the push notification screen recommends an oral rehydration solution rather than the sports drink as a risk of heatstroke of the user further increases.

16. The method according to claim 1, wherein
the biological information includes any one of a heart rate, a blood pressure, or an amount of perspiration of the user.

17. A communication terminal that executes the method according to claim 1.

18. A non-transitory computer-readable recording medium storing a program for causing a computer of a communication terminal to execute the method according to claim 1.

19. A method for a vending machine management system that manages stock information for a vending machine of drinks, the method comprising:
acquiring, from a communication terminal via a network, i) a user ID for identifying a user of the communication terminal, ii) identification information for identifying the vending machine, iii) type information indicating product names of a plurality of drinks stored in the vending machine, and iv) the stock information indicating quantities of stock of the plurality of drinks stored in the vending machine, wherein ii) the identification information, iii) the type information, and iv) the stock information are acquired in the communication terminal from the vending machine of drinks by using short-range wireless communication in response to receipt of a beacon signal from the vending machine;
transmitting the user ID to a personal information server that securely manages biological information that includes a body temperature or a body water percentage of the user of the communication terminal;
acquiring from the personal information server, the biological information of the user corresponding to the user ID, when it is confirmed at the personal information server that the acquisition of the biological information of the user is permitted by the user;
generating information of a push notification screen, based on the identification information, the type information, the stock information, and the biological information, wherein the push notification screen recommends at least one drink suitable for hydrating the user to prevent heatstroke, from among the plurality of drinks stored in the vending machine indicated by the identification information; and
outputting the information of the push notification screen to the communication terminal to display the push notification screen on a display of the communication terminal.

20. The method according to claim 19, wherein
the push notification screen is used for displaying, on the display of the communication terminal, a purchase menu that allows the at least one drink to be purchased from among the plurality of drinks stored in the vending machine.

21. The method according to claim 19, further comprising:
acquiring, from the communication terminal, information indicating that the push notification screen displayed on the display is selected;
generating information of an individual purchase menu for preventing heatstroke, based on the type information, the stock information, and the biological information, wherein the individual purchase menu displays the at least one drink suitable for hydrating the user to prevent heatstroke, from among the plurality of drinks stored in the vending machine indicated by the identification information; and
outputting the information of the individual purchase menu to the communication terminal to display the individual purchase menu on the display of the communication terminal.

22. The method according to claim 19, wherein
the at least one drink includes any one of water, a sports drink, or an oral rehydration solution.

23. The method according to claim 19, wherein
the push notification screen recommends, as the at least one drink, a sports drink rather than water as a risk of heatstroke of the user increases.

24. The method according to claim 23, wherein
the push notification screen recommends an oral rehydration solution rather than the sports drink as the risk of heatstroke of the user further increases.

25. The method according to claim 19, wherein
the biological information comprises information on a body temperature of the user, and
the push notification screen is displayed in response to an increase in the body temperature of the user by a predetermined amount.

26. The method according to claim 19, wherein
the biological information comprises information on a body temperature of the user, and
the push notification screen recommends, as the at least one drink, a sports drink rather than water as the body temperature of the user increases.

27. The method according to claim 26, wherein
the push notification screen recommends an oral rehydration solution rather than the sports drink as a risk of heatstroke of the user further increases.

28. The method according to claim 19, wherein
the biological information comprises information on a body water percentage of the user, and
the push notification screen is displayed in response to a decrease in the body water percentage of the user by a predetermined amount.

29. The method according to claim 19, wherein
the biological information comprises information on a body water percentage of the user, and
the push notification screen recommends, as the at least one drink, a sports drink rather than water as the body water percentage of the user decreases.

30. The method according to claim 29, wherein
the push notification screen recommends an oral rehydration solution rather than the sports drink as a risk of heatstroke of the user further increases.

31. The method according to claim 19, wherein
the biological information includes any one of a heart rate, a blood pressure, or an amount of perspiration of the user.

32. The method according to claim 1, wherein
in a case where permission of the user is not confirmed in the personal information server,
the biological information of the user corresponding to the user ID is acquired from the personal information server, when the personal information server receives a permission from the communication terminal, in reply to a message transmitted from the personal information server to the communication terminal for checking whether to permit the acquisition of the biological information of the user.

33. The method according to claim 19, wherein
in a case where permission of the user is not confirmed in the personal information server,
the biological information of the user corresponding to the user ID is acquired from the personal information server, when the personal information server receives a permission from the communication terminal, in replay to a message transmitted from the personal information server to the communication terminal for checking whether to permit reading of the biological information of the user.

34. A method executed in a communication terminal, the communication terminal including a user ID for identifying a user of the communication terminal,
the method comprising causing a computer of the communication terminal to perform a process comprising:
acquiring, in response to receipt of a beacon signal from a vending machine of drinks, from the vending machine by using short-range wireless communication, i) identification information for identifying the vending machine, ii) type information indicating product names of a plurality of drinks stored in the vending machine, and iii) stock information indicating quantities of stock of the plurality of drinks stored in the vending machine;
transmitting the user ID to a personal information server that securely manages personal information including biological information that includes a body temperature or a body water percentage of the user of the communication terminal;
acquiring from the personal information server, the biological information of the user corresponding to the user ID, when it is confirmed at the personal information server that the acquisition of the biological information of the user is permitted by the user;
calculating, based on the biological information, an increasing degree of the body temperature of the user or a decreasing degree of the body water percentage of the user;
generating a push notification screen, based on the identification information, the type information, the stock information, and the increasing degree of the body temperature of the user or the decreasing degree of the body water percentage of the user, wherein the push notification screen recommends at least one drink suitable for hydrating the user to prevent heatstroke, from among the plurality of drinks stored in the vending machine indicated by the identification information; and
displaying the push notification screen on a display of the communication terminal.

35. The method according to claim 34, wherein
the increasing degree of the body temperature of the user includes i) an increase amount of the body temperature of the user in a predetermined time or ii) an increase amount of the body temperature from a normal body temperature of the user, and
the decreasing degree of the body water percentage of the user includes i) a decrease amount of the body water percentage of the user in a predetermined time or ii) a decrease amount of the body water percentage from a normal body water percentage of the user.

36. A method for a vending machine management system that manages stock information for a vending machine of drinks, the method comprising:
acquiring, from a communication terminal via a network, i) a user ID for identifying a user of the communication terminal, ii) identification information for identifying the vending machine, iii) type information indicating product names of a plurality of drinks stored in the vending machine, and iv) stock information indicating quantities of stock of the plurality of drinks stored in the vending machine, wherein ii) the identification information, iii) the type information, and iv) the stock information are acquired in the communication terminal from the vending machine of drinks by using short-range wireless communication in response to receipt of a beacon signal from the vending machine;
transmitting the user ID to a personal information server that securely manages biological information that includes a body temperature or a body water percentage of the user of the communication terminal;
acquiring from the personal information server, the biological information of the user corresponding to the user ID, when it is confirmed at the personal information server that the acquisition of the biological information of the user is permitted by the user;
calculating, based on the biological information, an increasing degree of the body temperature of the user or a decreasing degree of the body water percentage of the user;
generating information of a push notification screen, based on the identification information, the type information, the stock information, and the increasing degree of the body temperature of the user or the decreasing degree of the body water percentage of the user, wherein the push notification screen recommends at least one drink suitable for hydrating the user to prevent heatstroke, from among the plurality of drinks stored in the vending machine indicated by the identification information; and
outputting the information of the push notification screen to the communication terminal to display the push notification screen on a display of the communication terminal.

37. The method according to claim 36, wherein
the increasing degree of the body temperature of the user includes i) an increase amount of the body temperature of the user in a predetermined time or ii) an increase amount of the body temperature from a normal body temperature of the user, and
the decreasing degree of the body water percentage of the user includes i) a decrease amount of the body water percentage of the user in a predetermined time or ii) a decrease amount of the body water percentage from a normal body water percentage of the user.

38. A method executed in a communication terminal, the communication terminal including a user ID for identifying a user of the communication terminal,
the method comprising causing a computer of the communication terminal to perform a process comprising:
in response to receipt, by using short-range wireless communication, of a beacon signal from a sales site of a business entity that sells drinks, acquiring from the sales site, i) type information for identifying a plurality of drinks sold at the sales site and ii) stock information of the plurality of drinks sold at the sales site;
transmitting the user ID to a first server that securely manages personal information including biological information that includes a body temperature or a body water percentage of the user;
acquiring the biological information from the first server, the biological information being provided in response to confirmation in the first server that the user permits the business entity that sells the drinks to access the biological information; and
displaying, on a display of the communication terminal, a notification screen that recommends at least one drink to the user based on at least the type information, the stock information, and the biological information.
